(19) United States
(12) Patent Application Publication
(10) Pub. No.: US 2022/0007356 A1
(43) Pub. Date: Jan. 6, 2022

(54) TERMINAL APPARATUS, BASE STATION APPARATUS, AND COMMUNICATION METHOD

(71) Applicant: SHARP KABUSHIKI KAISHA, Sakai City, Osaka (JP)

(72) Inventors: TAEWOO LEE, Sakai City, Osaka (JP); SHOICHI SUZUKI, Sakai City, Osaka (JP); WATARU OUCHI, Sakai City, Osaka (JP); TOMOKI YOSHIMURA, Sakai City, Osaka (JP); TOSHIZO NOGAMI, Sakai City, Osaka (JP); HUIFA LIN, Sakai City, Osaka (JP)

(21) Appl. No.: 17/290,426

(22) PCT Filed: Nov. 1, 2019
(86) PCT No.: PCT/JP2019/043047

§ 371 Date: Apr. 30, 2021

(30) Foreign Application Priority Data
Nov. 1, 2018 (JP) 2018-206556

(51) Int. Cl. H04W 72/04

(52) U.S. Cl. CPC H04W 72/0413; H04W 72/0446

(57) ABSTRACT

Transmission in uplink and downlink can be efficiently performed. A terminal apparatus includes a processing unit configured to resolve overlapping of multiple PUCCH resources, and a transmitter configured to transmit a PUCCH as an output of the processing unit, wherein in a case that a first PUCCH resource overlaps a second PUCCH resource, the processing unit multiplexes first UCI included in the first PUCCH resource and second UCI included in the second PUCCH resource into a third PUCCH resource, and a first parameter N_{PUCCH}^{repeat} for a first PUCCH format of the first PUCCH resource and a second parameter N_{PUCCH}^{repeat} for a second PUCCH format of the second PUCCH resource are expected to be identical to a third parameter N_{PUCCH}^{repeat} for a third PUCCH format of the third PUCCH resource.

### TECHNICAL FIELD

The present invention relates to a terminal apparatus, a base station apparatus, and a communication method. This application claims priority based on JP 2018-206556 filed on Nov. 1, 2018, the contents of which are incorporated herein by reference.

### BACKGROUND ART

A radio access method and a radio network for cellular mobile communications (hereinafter, referred to as “Long Term Evolution (LTE: registered trademark)”, or “Evolved Universal Terrestrial Radio Access (EUTRA)”) have been studied in the 3rd Generation Partnership Project (3GPP). Further, in 3GPP, a new radio access method (hereinafter referred to as “New Radio (NR)”) is being studied (NPLs 1, 2, 3, 4). In LTE, a base station apparatus is also referred to as an evolved NodeB (eNodeB). In NR, a base station apparatus is also referred to as a gNodeB. In LTE, and in NR, a terminal apparatus is also referred to as a User Equipment (UE). LTE, as well as NR, is a cellular communication system in which multiple areas are deployed in a cellular structure, with each of the multiple areas being covered by a base station apparatus. A single base station apparatus may manage multiple cells.

In NR, a set of downlink BWP (bandwidth part) and uplink BWP is configured for one serving cell (NPL 3). The terminal apparatus receives PDCCH and PDSCH in the downlink BWP.

### CITATION LIST

### Non Patent Literature

NPL 1: “3GPP TS 38.211 V15.3.0 (2018-09), NR; Physical channels and modulation”

NPL 2: “3GPP TS 38.212 V15.3.0 (2018-09), NR; Multiplexing and channel coding”

NPL 3: “3GPP TS 38.213 V15.3.0 (2018-09), NR; Physical layer procedures for control”

NPL 4: “3GPP TS 38.214 V15.3.0 (2018-09), NR; Physical layer procedures for data”

NPL 5: “3GPP TS 38.331 V15.3.0 (2018-09), NR; Physical layer procedures for data”

### SUMMARY OF INVENTION

### Technical Problem

One aspect of the present invention provides a terminal apparatus capable of efficiently performing communication, a communication method used for the terminal apparatus, a base station apparatus capable of efficiently performing communication, and a communication method used for the base station apparatus.

### SOLUTION TO PROBLEM

(1) A first aspect of the present invention is a terminal apparatus including a processing unit configured to resolve overlapping of multiple PUCCH resources, and a transmitter configured to transmit a PUCCH as an output of the processing unit, wherein in a case that a first PUCCH resource overlaps a second PUCCH resource, the processing unit multiplexes first UCI included in the first PUCCH resource and second UCI included in the second PUCCH resource into a third PUCCH resource, a first parameter N_{PUCCH}^{repeat} for a first PUCCH format of the first PUCCH resource and a second parameter N_{PUCCH}^{repeat} for a second PUCCH format of the second PUCCH resource are expected to be identical to a third parameter N_{PUCCH}^{repeat} for a third PUCCH format of the third PUCCH resource, the first parameter N_{PUCCH}^{repeat} is related to the number of slots in which the first PUCCH resource having the first PUCCH format is repeated, the second parameter N_{PUCCH}^{repeat} is related to the number of slots in which the second PUCCH resource having the second PUCCH format is repeated, the third parameter N_{PUCCH}^{repeat}is related to the number of slots in which the third PUCCH resource having the third PUCCH format is repeated, and the third PUCCH format is different from the first PUCCH format and the second PUCCH format.

(2) A second aspect of the present invention is a base station apparatus including a processing unit configured to resolve overlapping of multiple PUCCH resources, and a receiver configured to receive a PUCCH as an output of the processing unit, wherein in a case that a first PUCCH resource overlaps a second PUCCH resource, the processing unit multiplexes first UCI included in the first PUCCH resource and second UCI included in the second PUCCH resource into a third PUCCH resource, a first parameter N_{PUCCH}^{repeat} for a first PUCCH format of the first PUCCH resource and a second parameter N_{PUCCH}^{repeat} for a second PUCCH format of the second PUCCH resource are configured to be identical to a third parameter N_{PUCCH}^{repeat} for a third PUCCH format of the third PUCCH resource, the first parameter N_{PUCCH}^{repeat} is related to the number of slots in which the first PUCCH resource having the first PUCCH format is repeated, the second parameter N_{PUCCH}^{repeat} is related to the number of slots in which the second PUCCH resource having the second PUCCH format is repeated, the third parameter N_{PUCCH}^{repeat} is related to the number of slots in which the third PUCCH resource having the third PUCCH format is repeated, and the third PUCCH format is different from the first PUCCH format and the second PUCCH format.

(3) A third aspect of the present invention is a communication method used for a terminal apparatus, the communication method including a step of resolving overlapping of multiple PUCCH resources, and a step of transmitting a PUCCH as an output of the processing unit, wherein in a case that a first PUCCH resource overlaps a second PUCCH resource, the processing step includes multiplexing first UCI included in the first PUCCH resource and second UCI included in the second PUCCH resource into a third PUCCH resource, a first parameter N_{PUCCH}^{repeat} for a first PUCCH format of the first PUCCH resource and a second parameter N_{PUCCH}^{repeat} for a second PUCCH format of the second PUCCH resource are expected to be identical to a third parameter N_{PUCCH}^{repeat} for a third PUCCH format of the third PUCCH resource, the first parameter N_{PUCCH}^{repeat} is related to the number of slots in which the first PUCCH resource having the first PUCCH format is repeated, the second parameter N_{PUCCH}^{repeat} is related to the number of slots in which the second PUCCH resource having the second PUCCH format is repeated, the third parameter N_{PUCCH}^{repeat} is related to the number of slots in which the third PUCCH resource having the third PUCCH format is repeated, and the third PUCCH format is different from the first PUCCH format and the second PUCCH format.

(4) A fourth aspect of the present invention is a communication method used for a base station apparatus, the communication method including the steps of resolving overlapping of multiple PUCCH resources, and transmitting a PUCCH as an output of the processing unit, wherein in a case that a first PUCCH resource overlaps a second PUCCH resource, the processing step includes multiplexing first UCI included in the first PUCCH resource and second UCI included in the second PUCCH resource into a third PUCCH resource, a first parameter N_{PUCCH}^{repeat} for a first PUCCH format of the first PUCCH resource and a second parameter N_{PUCCH}^{repeat} for a second PUCCH format of the second PUCCH resource are expected to be identical to a third parameter N_{PUCCH}^{repeat} for a third PUCCH format of the third PUCCH resource, the first parameter N_{PUCCH}^{repeat} is related to the number of slots in which the first PUCCH resource having the first PUCCH format is repeated, the second parameter N_{PUCCH}^{repeat} is related to the number of slots in which the second PUCCH resource having the second PUCCH format is repeated, the third parameter N_{PUCCH}^{repeat} is related to the number of slots in which the third PUCCH resource having the third PUCCH format is repeated, and the third PUCCH format is different from the first PUCCH format and the second PUCCH format.

### ADVANTAGEOUS EFFECTS OF INVENTION

According to one aspect of the present invention, the terminal apparatus can efficiently perform communication. In addition, the base station apparatus can efficiently perform communication.

### BRIEF DESCRIPTION OF DRAWINGS

FIG. 1 is a conceptual diagram of a radio communication system according to the present embodiment.

FIG. 2 is an example illustrating a relationship between N^{slot}_{symb}, a subcarrier spacing configuration μ, and a CP configuration according to an aspect of the present embodiment.

FIG. 3 is a schematic diagram illustrating an example of a resource grid in a subframe according to an aspect of the present embodiment.

FIG. 4 is a schematic block diagram illustrating a configuration of a terminal apparatus 1 according to the present embodiment.

FIG. 5 is a schematic block diagram illustrating a configuration of a base station apparatus 3 according to the present embodiment.

FIG. 6 is a diagram illustrating an example in which a PUCCH resource is configured by higher layer parameters according to the present embodiment.

FIG. 7 is a diagram illustrating an example of an ordering method of a set Q of PUCCH resources in the present embodiment.

FIG. 8 is a diagram illustrating an example of a procedure in a case that one or multiple PUCCH resources included in the set Q of PUCCH resources in one slot overlap in the present embodiment.

### DESCRIPTION OF EMBODIMENTS

Embodiments of the present invention will be described below.

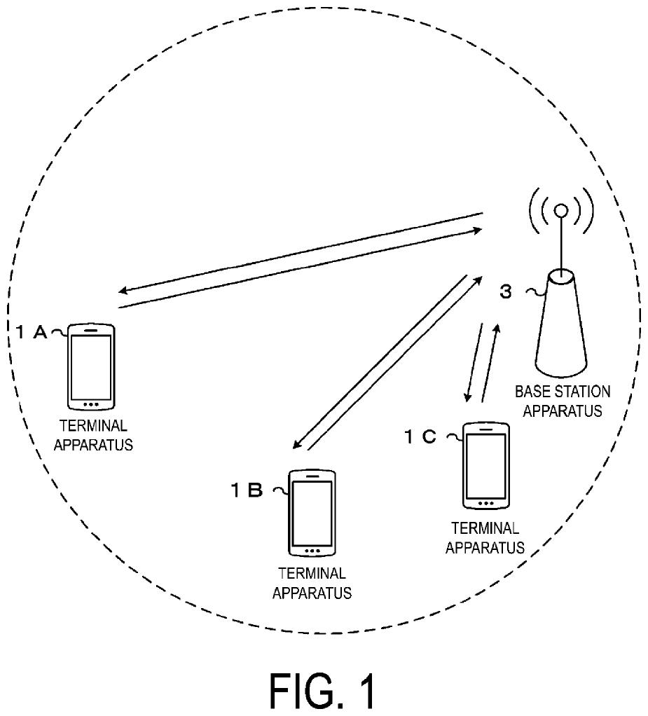

FIG. 1 is a conceptual diagram of a radio communication system according to the present embodiment. In FIG. 1, the radio communication system includes terminal apparatuses 1A to 1C and a base station apparatus 3. The terminal apparatuses 1A to 1C are each referred to as a terminal apparatus 1.

The base station apparatus 3 may include one or both of a Master Cell Group (MCG) and a Secondary Cell Group (SCG). The MCG is a group of serving cells including at least a Primary Cell (PCell). The SCG is a group of serving cells including at least a Primary Secondary Cell (PSCell). The PCell may be a serving cell provided based on an initial connection. The MCG may include one or multiple Secondary Cells (SCells). The SCG may include one or multiple SCells.

The MCG may include a serving cell on the EUTRA. The SCG may include s serving cell on the next generation standard (New Radio (NR)).

Hereinafter, a frame configuration will be described.

In the radio communication system according to an aspect of the present embodiment, at least Orthogonal Frequency Division Multiplexing (OFDM) is used. An OFDM symbol is a unit of a time domain for the OFDM. The OFDM symbol includes at least one or multiple subcarriers. The OFDM symbol is converted into a time-continuous signal in generating a baseband signal. In downlink, at least Cyclic Prefix-Orthogonal Frequency Division Multiplex (CP-OFDM) is used. In uplink, either the CP-OFDM or Discrete Fourier Transform spread-Orthogonal Frequency Division Multiplex (DFT-s-OFDM) is used. The DFT-s-OFDM may be given by applying Transform precoding to the CP-OFDM.

The OFDM symbol including a CP added to the OFDM symbol may also be referred to the OFDM symbol. In other words, an OFDM symbol may include the OFDM symbol itself and a CP added to the OFDM symbol itself.

A SubCarrier Spacing (SCS) may be given by a subcarrier spacing Δf=2 μ*15 kHz. For example, a subcarrier spacing configuration μ may be set to any of 0, 1, 2, 3, 4, and/or 5. For a BandWidth Part (BWP), the subcarrier spacing configuration μ may be given by a higher layer parameter.

In the radio communication system according to an aspect of the present embodiment, a time unit T_{c} is used for representing a length in the time domain. The time unit T_{c} may be given as T_{c}=1/(Δfₘₐₓ*N_{f}). Δfmax may be the maximum value of the subcarrier spacing supported by the radio communication system according to an aspect of the present embodiment. Δfmax may be Δfₘₐₓ=480 kHz. N_{f} may be N_{f}=4096. A constant κ is κ=Δfₘₐₓ*N_{f}/(Δf_{ref}N_{f, ref})=64. Δf_{ref} may be 15 kHz. N_{f, ref} may be 2048.

The constant κ may be a value indicating a relationship between a reference subcarrier spacing and T_{c}. The constant κ may be used for a length of a subframe. The number of slots included in the subframe may be given at least based on the constant κ. Δf_{ref} is the reference subcarrier spacing, and N_{f}, ref is a value corresponding to the reference subcarrier spacing.

A signal transmission in the downlink and/or a signal transmission in the uplink includes a frame of 10 ms. A frame is configured to include 10 subframes. A length of the subframe is 1 ms. A length of the frame may be given regardless of the subcarrier spacing Δf. That is, a frame configuration may be given regardless of The length of the subframe may be given regardless of the subcarrier spacing Δf. That is, a subframe configuration may be given regardless of μ.

For a subcarrier spacing configuration μ, the number and indices of slots included in a subframe may be given. For example, a slot number n^{μ}ₛ may be given in ascending order ranging from 0 to N^{subframe, μ}ₛₗₒₜ−1 in a subframe. For the subcarrier spacing configuration μ, the number and indices of slots included in a frame may be given. Moreover, a slot number n^{μ}_{s, f} may be given in ascending order ranging from 0 to N^{frame, μ}ₛₗₒₜ−1 within a frame. N^{slot}_{symb} consecutive OFDM symbols may be included in one slot. N^{slot}_{symb} may be given at least based on part or all of a Cyclic Prefix (CP) configuration. The CP configuration may be given at least based on a higher layer parameter. The CP configuration may be given at least based on dedicated RRC signaling. The slot number is also referred to as a slot index.

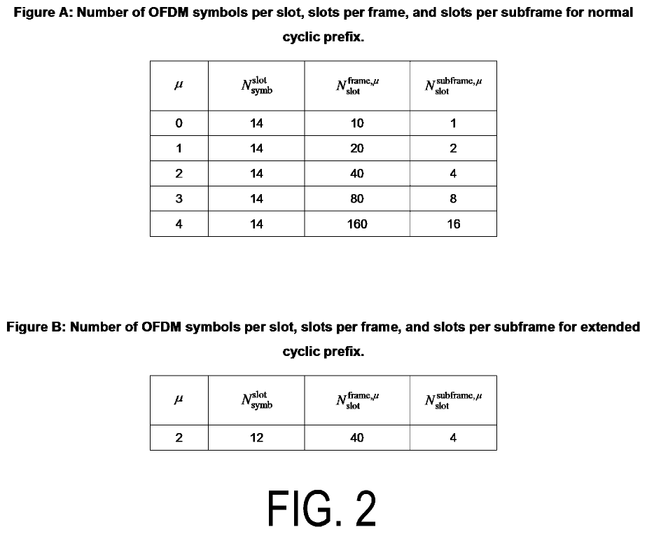

FIG. 2 is an example illustrating a relationship between N^{slot}_{symb}, the subcarrier spacing configuration μ, and the CP configuration according to an aspect of the present embodiment. In FIG. 2A, for example, in a case that the subcarrier spacing configuration μ is 2 and the CP configuration is a normal cyclic prefix (normal CP), N^{slot}_{symb}=14, N^{frame,μ}ₛₗₒₜ=40, and N^{subframe, μ}ₛₗₒₜ=4. In FIG. 2B, for example, in a case that the subcarrier spacing configuration μ is 2 and the CP configuration is an extended cyclic prefix (extended CP), N^{slot}_{symb}=12, N^{frame, μ}ₛₗₒₜ=40, and N^{subframe, μ}ₛₗₒₜ=4.

Physical resources will be described below.

An antenna port is defined in such a manner that a channel on which a symbols on one antenna port is conveyed can be inferred from a channel on which another symbol on the same antenna port is conveyed. In a case that a large scale property of the channel on which the symbol on one antenna port is conveyed can be inferred from the channel on which the symbol on another antenna port is conveyed, the two antenna ports are said to be Quasi Co-Located (QCL). The large scale property may include at least a long term performance of the channel. The large scale property may include at least some or all of delay spread, Doppler spread, Doppler shift, average gain, average delay, and beam parameters (spatial Rx parameters). A first antenna port and a second antenna port being QCL with respect to a beam parameter may mean that a reception beam assumed by the reception side for the first antenna port may be the same as a reception beam assumed by the reception side for the second antenna port. The first antenna port and the second antenna port being QCL with respect to a beam parameter may mean that a transmission beam assumed by the reception side for the first antenna port may be the same as a transmission beam assumed by the reception side for the second antenna port. In a case that the terminal apparatus 1 can estimate the large scale property of the channel on which the symbol on one antenna port is conveyed from the channel on which the symbol on another antenna port is conveyed, the two antenna ports may be assumed to be QCL. Two antenna ports being QCL may mean that the two antenna ports are assumed to be QCL.

For the subcarrier spacing configuration and a set of carriers, a resource grid defined by N^{size,μ}_{grid, x}N^{RB}_{sc} subcarriers and N^{subframe, μ}_{symb} OFDM symbols is given. N^{size,μ}_{grid, x} may indicate the number of resource blocks given for the subcarrier spacing configuration μ for a carrier x. N^{size, μ}_{grid, x} may indicate a bandwidth of the carrier. N^{size,μ}_{grid, x} may correspond to a value of a higher layer parameter CarrierBandwidth. The carrier x may indicate either a downlink carrier or an uplink carrier. In other words, x may be either “DL” or “UL.” N^{RB}_{sc} may indicate the number of subcarriers included in one resource block. N^{RB}_{SC} may be 12. At least one resource grid may be provided for each antenna port p and/or for each subcarrier spacing configuration μ and/or for each Transmission direction configuration. The transmission direction includes at least Downlink (DL) and Uplink (UL). Hereinafter, a set of parameters including at least some or all of the antenna port p, the subcarrier spacing configuration μ, and the transmission direction configuration is also referred to as a first radio parameter set. That is, one resource grid may be given for each first radio parameter set.

A carrier included in a serving cell in the downlink is referred to as a downlink carrier (or a downlink component carrier). A carrier included in a serving cell in the uplink is referred to as an uplink carrier (or an uplink component carrier). The downlink component carrier and the uplink component carrier are collectively referred to as a component carrier (o a carrier).

A type of the serving cell may be either the PCell, the PSCell, or the SCell. The PCell may be a serving cell identified at least based on a cell ID acquired from an SS/PBCH in the initial connection. The SCell may be a serving cell used in carrier aggregation. The SCell may be a serving cell given at least based on dedicated RRC signaling.

Each element in the resource grid given for each first radio parameter set is referred to as a resource element. The resource element is identified by an index k_{sc} of a frequency domain and an index l_{sym} of a time domain. For a first radio parameter set, a resource element is identified by an index k_{sc} of the frequency domain and an index l_{sym} of the time domain. The resource element identified by the index k_{sc} of the frequency domain and the index l_{sym} of the time domain is also referred to as a resource element (k_{sc}, l_{sym}). The index k_{sc} of the frequency domain indicates any value from 0 to N^{μ}_{RB9}N^{RB}_{sc}−1. N^{μ}_{RB} may be the number of resource blocks given for the subcarrier spacing configuration μ. N^{μ}_{RB} may be N^{size, μ}_{grid, x}. N^{RB}_{sc} is the number of subcarriers included in a resource block, and N^{RB}_{sc}=12. The index k_{sc} of the frequency domain may correspond to a subcarrier index k_{sc}. The index l_{sym} of the time domain may correspond to an OFDM symbol index l_{sym}.

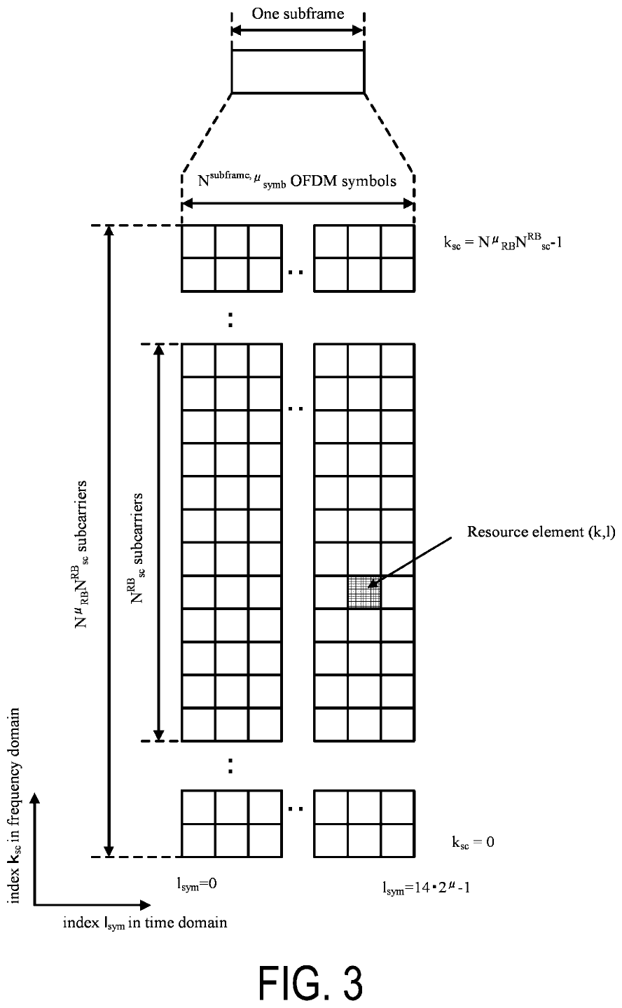

FIG. 3 is a schematic diagram illustrating an example of a resource grid in a subframe according to an aspect of the present embodiment. In the resource grid of FIG. 3, a horizontal axis is the index l_{sym} of the time domain and a vertical axis is the index k_{sc} of the frequency domain. In one subframe, the frequency domain of the resource grid includes N^{μ}_{RB}N^{RB}_{sc} subcarriers. In one subframe, the time domain of the resource grid may include 14*2 μ OFDM symbols. One resource block includes N^{RB}_{sc} subcarriers. The time domain of the resource block may correspond to one OFDM symbol. The time domain of the resource block may correspond to 14 OFDM symbols. The time domain of the resource block may correspond to one or multiple slots. The time domain of the resource block may correspond to one subframe.

The terminal apparatus 1 may receive indication to perform transmission and/or reception by using only a subset of the resource grid. The subset of the resource grids is also referred to as a BWP, and the BWP may be given at least based on part or all of higher layer parameters and/or the DCI. The BWP is also referred to as a Carrier BandWidth Part. The terminal apparatus 1 may not receive indication to perform transmission and/or reception by using all sets of resource grids. The terminal apparatus 1 may receive indication to perform transmission and/or reception using some frequency resources in the resource grid. One BWP may include multiple resource blocks in the frequency domain. One BWP may include multiple resource blocks continuous in the frequency domain. The BWP configured for the downlink carrier is also referred to as a downlink BWP. The BWP configured for the uplink carrier is also referred to as an uplink BWP. The BWP may be a subset of the bands of the carrier.

One or multiple downlink BWPs may be configured for each serving cell. One or multiple uplink BWPs may be configured for each serving cell.

One downlink BWP among the one or multiple downlink BWPs configured for the serving cell may be configured in an active downlink BWP. A downlink BWP switch is used to deactivate one active downlink BWP and activate inactive downlink BWPs other than the one active downlink BWP. The downlink BWP switch may be controlled by a BWP field included in downlink control information. The downlink BWP switch may be controlled based on a higher layer parameter.

A DL-SCH may be received in the active downlink BWP. A PDCCH may be monitored in the active downlink BWP. A PDSCH may be received in the active downlink BWP.

The DL-SCH is not received in the inactive downlink BWP. The PDCCH is not monitored in the inactive downlink BWP. CSI for the inactive downlink BWP is not reported.

Two or more downlink BWPs among one or multiple downlink BWPs configured for the serving cell may not be configured in the active downlink BWP.

One uplink BWP among one or multiple uplink BWPs configured for the serving cell may be configured in the active uplink BWP. An uplink BWP switch is used to deactivate one active uplink BWP and activate inactive uplink BWPs other than the one active uplink BWP. The uplink BWP switch may be controlled by a BWP field included in downlink control information. The uplink BWP switch may be controlled based on a higher layer parameter.

A UL-SCH may be transmitted in the active uplink BWP. A PUCCH may be transmitted in the active uplink BWP. A PRACH may be transmitted in the active uplink BWP. An SRS may be transmitted in the active uplink BWP.

The UL-SCH is not transmitted in the inactive uplink BWP. The PUCCH is not transmitted in the inactive uplink BWP. The PRACH is not transmitted in the inactive uplink BWP. The SRS is not transmitted in the inactive uplink BWP.

Two or more uplink BWPs among one or multiple uplink BWPs configured for the serving cell may not be configured in the active uplink BWP.

A higher layer parameter is a parameter included in higher layer signaling. The higher layer signaling may be a Radio Resource Control (RRC) signaling or a Medium Access Control (MAC) Control Element (CE). Here, the higher layer signaling may be RRC layer signaling or MAC layer signaling.

The higher layer signaling may be common RRC signaling. The common RRC signaling may include at least some or all of the following features C1 to C3.
Feature C1) Being mapped to a BCCH logical channel or a CCCH logical channel.
Feature C2) Including at least a ReconfigrationWithSync information element.
Feature C3) Being mapped to a PBCH.

The ReconfigrationWithSync information element may include information indicating a configuration commonly used in the serving cell. The configuration commonly used in the serving cell may include at least a PRACH configuration. The PRACH configuration may indicate at least one or multiple random access preamble indexes. The PRACH configuration may indicate at least a time/frequency resource of a PRACH.

The common RRC signaling may include at least a common RRC parameter. The common RRC parameter may be a Cell-specific parameter commonly used in the serving cell.

The higher layer signaling may be dedicated RRC signaling. The dedicated RRC signaling may include at least some or all of the following features D1 and D2.
Feature D1) Being mapped to a DCCH logical channel.
Feature D2) Not including a ReconfigrationWithSync information element.

For example, a Master Information Block (MIB) and a System Information Block (SIB) may be included in the common RRC signaling. In addition, a higher layer message that is mapped to the DCCH logical channel and includes at least the ReconfigrationWithSync information element may be included in the common RRC signaling. In addition, a higher layer message that is mapped to the DCCH logical channel and does not include the ReconfigrationWithSync information element may be included in the dedicated RRC signaling.

The SIB may indicate at least a time index of a Synchronization Signal (SS) block. The SS block is also referred to as an SS/PBCH block. The SIB may include at least information related to a PRACH resource. The SIB may include at least information related to a configuration of the initial connection.

The ReconfigrationWithSync information element may include at least information related to the PRACH resource. The ReconfigrationWithSync information element may include at least information related to the configuration of the initial connection.

The dedicated RRC signaling may include at least a dedicated RRC parameter. The dedicated RRC parameter may be a (UE-specific) parameter used exclusively for the terminal apparatus 1. The dedicated RRC signaling may include at least a common RRC parameter.

The common RRC parameter and the dedicated RRC parameter are also

referred to as higher layer parameters. Physical channels and physical signals according to the present

embodiment will be described. An uplink physical channel may correspond to a set of resource elements that conveys information generated in a higher layer. The uplink physical channel is a physical channel used in the uplink carrier. In the radio communication system according to an aspect of the present embodiment, at least some or all of the uplink physical channels described below are used.
Physical Uplink Control CHannel (PUCCH)
Physical Uplink Shared CHannel (PUSCH)
Physical Random Access CHannel (PRACH)

The PUCCH is used for the terminal apparatus 1 to transmit Uplink Control Information (UCI) to the base station apparatus 3. Note that in the present embodiment, the terminal apparatus 1 may transmit the PUCCH in a primary cell and/or a secondary cell having a function of the primary cell and/or a secondary cell capable of transmitting the PUCCH. Specifically, the PUCCH may be transmitted in a particular serving cell.

The PUCCH supports PUCCH formats (PUCCH format 0 to PUCCH format 4). The PUCCH format may be transmitted on the PUCCH. The PUCCH format being transmitted may be the PUCCH being transmitted.

The uplink control information includes at least one of downlink channel state information (CSI), a scheduling request (SR) indicating a request for a PUSCH resource, and a hybrid automatic repeat request acknowledgement (HARQ-ACK) for downlink data (a transport block, a medium access control protocol data unit (MAC PDU), a downlink-shared channel (DL-SCH), or a physical downlink shared channel (PDSCH)).

The HARQ-ACK is also referred to as an ACK/NACK, HARQ feedback, HARQ-ACK feedback, a HARQ response, a HARQ-ACK response, HARQ information, HARQ-ACK information, HARQ control information, and HARQ-ACK control information. In a case that downlink data is successfully decoded, an ACK for the downlink data is generated. In a case that the downlink data is not successfully decoded, a NACK for the downlink data is generated. Discontinuous Transmission (DTX) may mean that the downlink data has not been detected. The discontinuous Transmission (DTX) may mean that data for which a HARQ-ACK response is to be transmitted has not been detected. The HARQ-ACK may include at least a HARQ-ACK bit corresponding to at least one transport block. The HARQ-ACK bit may indicate an acknowledgement (ACK) or a negative-acknowledgement (NACK) corresponding to one or multiple transport blocks. The HARQ-ACK may include at least a HARQ-ACK codebook including one or multiple HARQ-ACK bits. The HARQ-ACK bit corresponding to one or multiple transport blocks may be the HARQ-ACK bit corresponding to a PDSCH including the one or multiple transport blocks.

The HARQ-ACK bit may indicate an ACK or a NACK corresponding to one code block group (CBG) included in the transport block. The HARQ-ACK is also referred to as HARQ feedback, HARQ information, and HARQ control information.

The channel state information (CSI) may include a channel quality indicator (CQI) and a rank indicator (RI). The channel quality indicator may include a precoder matrix indicator (PMI) and a CSI-RS indicator (CRI). The channel state information may include a precoder matrix indicator. The CQI is an indicator associated with channel quality (propagation strength), and the PMI is an indicator indicating a precoder. The RI is an indicator indicating a transmission rank (or the number of transmission layers). The CSI is also referred to as a CSI report or CSI information.

The CSI report may be divided into one or multiple pieces. For example, in a case that the CSI report is divided into two, the divided first CSI report may be a CSI-part 1 and the divided second CSI report may be a CSI-part 2. A size of the CSI report may be a number of bits of some or all of the pieces of the divided CSI. The size of the CSI report may be the number of bits of the CSI-part 1. The size of the CSI report may be the number of bits of the CSI-part 2. The size of the CSI report may be a total sum of the numbers of bits of the multiple divided CSI reports. The total sum of the numbers of bits of multiple pieces of divided CSI is the number of bits of the CSI report before being divided. The CSI-part 1 may include at least a part or all of any of the RI, the CRI, the CQI, and the PMI. The CSI-part 2 may include a part or all of any of the PMI, the CQI, the RI, and the CRI.

The channel state information may include at least some or all of the channel quality indicator (CQI), the precoder matrix indicator (PMI), and the rank indicator (RI). The CQI is an indicator associated with channel quality (for example, propagation strength), and the PMI is an indicator indicating a precoder. The RI is an indicator indicating a transmission rank (or the number of transmission layers).

The channel state information may be given at least based on receiving a physical signal (e.g., CSI-RS) that is at least used for channel measurement. The channel state information may include a value selected by the terminal apparatus 1. The channel state information may be selected by the terminal apparatus 1 at least based on receiving the physical signal that is at least used for the channel measurement. The channel measurement includes interference measurement.

A channel state information report is a report of the channel state information. The channel state information report may include a CSI part 1 and/or a CSI part 2. The CSI part 1 may include at least some or all of wideband channel quality information (wideband CQI), a wideband precoder matrix indicator (wideband PMI), and a rank indicator. The number of bits of the CSI part 1 multiplexed on the PUCCH may be a prescribed value regardless of a value of the rank indicator of the channel state information report. The number of bits of the CSI part 2 multiplexed on the PUCCH may be given based on the value of the rank indicator of the channel state information report. The rank indicator of the channel state information report may be a value of the rank indicator used to calculate the channel state information report. The rank indicator of the channel state information may be a value indicated by a rank indicator field included in the channel state information report.

A set of rank indicators permitted in the channel state information report may be part or all of 1 to 8. The set of rank indicators permitted in the channel state information report may be given at least based on a higher layer parameter RankRestriction. In a case that the set of rank indicators permitted in the channel state information report includes only one value, the rank indicator of the channel state information report may be the one value.

A priority may be configured for the channel state information report. The priority of the channel state information report may be given at least based on some or all of a configuration related to a time domain behavior of the channel state information report, a type of content of the channel state information report, an index of the channel state information report, and/or an index of a serving cell configured with measurement of the channel state information report.

The configuration related to the time domain behavior of the channel state information report may be a configuration indicating whether the channel state information report is performed aperiodically, semi-persistently, or semi-statically.

The type of content of the channel state information report may indicate whether the channel state information report includes a Reference Signals Received Power (RSRP) of a layer 1.

The index of the channel state information report may be given by a higher layer parameter.

The scheduling request (SR) may be used at least to request a PUSCH resource for an initial transmission. A scheduling request bit may be used to indicate either a positive SR or a negative SR. The scheduling request bit indicating the positive SR is also referred to as a “positive SR is transmitted.” The positive SR may indicate that the PUSCH resource for the initial transmission is requested by the terminal apparatus 1. The positive SR may indicate that a scheduling request is triggered by a higher layer. The positive SR may be transmitted in case that a scheduling request is indicated to be transmitted by the higher layer. The scheduling request bit indicating the negative SR is also referred to as a “negative SR is transmitted.” The negative SR may indicate that the PUSCH resource for the initial transmission is not requested by the terminal apparatus 1. The negative SR may indicate that a scheduling request is not triggered by the higher layer. The negative SR may be transmitted in a case that a scheduling request is not indicated to be transmitted by the higher layer.

The scheduling request bit may be used to indicate either a positive SR or a negative SR for either one or multiple SR configurations. Each of the one or multiple SR configurations may correspond to one or multiple logical channels. A positive SR for a given SR configuration may be a positive SR for any or all of the one or multiple logical channels corresponding to the given SR configuration. The negative SR may not correspond to a particular SR configuration. The negative SR being indicated may be the negative SR being indicated for the all SR configurations.

The SR configuration may be a scheduling request ID. The scheduling request ID may be given by a higher layer parameter.

The PUSCH may be used to transmit uplink data (Transport block, Medium Access Control Protocol Data Unit (MAC PDU), or Uplink-Shared Channel (UL-SCH)). The PUSCH may be used to transmit a HARQ-ACK and/or channel state information along with the uplink data. Furthermore, the PUSCH may be used to transmit only the channel state information or to transmit only the HARQ-ACK and the channel state information. In other words, the PUSCH may be used to transmit the uplink control information. The terminal apparatus 1 may transmit the PUSCH based on detection of a PDCCH (Physical Downlink Control Channel) including uplink grant.

The PRACH may be used at least to transmit a random access preamble (random access message 1). The PRACH may be used at least to indicate some or all of an initial connection establishment procedure, a handover procedure, a connection re-establishment procedure, synchronization (timing adjustment) for PUSCH transmission, and a request for the PUSCH resource. The random access preamble may be used to notify the base station apparatus 3 of an index (random access preamble index) given by a higher layer of the terminal apparatus 1.

The random access preamble may be given by cyclic-shifting a Zadoff-Chu sequence corresponding to a physical root sequence index u. The Zadoff-Chu sequence may be generated based on the physical root sequence index u. In one serving cell, multiple random access preambles may be defined. A random access preamble may be identified at least based on an index of the random access preamble. A different random access preamble corresponding to a different index of the random access preamble may correspond to a different combination of the physical root sequence index u and the cyclic shift. The physical root sequence index u and the cyclic shift may be given at least based on information included in system information. The physical root sequence index u may be an index for identifying a sequence included in the random access preamble. The random access preamble may be identified at least based on the physical root sequence index u.

In FIG. 1, the following uplink physical signals are used for uplink radio communication from the terminal apparatus 1 to the base station apparatus 3. The uplink physical signals may not be used to transmit information output from a higher layer, but is used by a physical layer.
UpLink Demodulation Reference Signal (UL DMRS)
Sounding Reference Signal (SRS)
UpLink Phase Tracking Reference Signal (UL PTRS)

The UL DMRS is associated with transmission of a PUSCH and/or a PUCCH. The UL DMRS is multiplexed with the PUSCH or the PUCCH. The base station apparatus 3 may use the UL DMRS in order to perform channel compensation of the PUSCH or the PUCCH. Transmission of both a PUSCH and a UL DMRS associated with the PUSCH will be hereinafter referred to simply as transmission of a PUSCH. Transmission of both a PUCCH and a UL DMRS associated with the PUCCH will be hereinafter referred to simply as transmission of a PUCCH. The UL DMRS associated with the PUSCH is also referred to as a UL DMRS for a PUSCH. The UL DMRS associated with the PUCCH is also referred to as a UL DMRS for a PUCCH. The SRS may not be associated with transmission of the PUSCH or the PUCCH. The base station apparatus 3 may use the SRS for measuring a channel state. The SRS may be transmitted at the end of a subframe in an uplink slot or in a predetermined number of OFDM symbols from the end. The UL PTRS may be a reference signal that is at least used for phase tracking. The UL PTRS may be associated with a UL DMRS group including at least an antenna port used for one or multiple UL DMRSs. The association of the UL PTRS with UL DMRS group may mean that the antenna port for the UL PTRS and some or all of the antenna ports included in the UL DMRS group are at least QCL. The UL DMRS group may be identified at least based on the antenna port of the lowest index for the UL DMRS included in the UL DMRS group. The UL PTRS may be mapped to the lowest index antenna port of one or multiple antenna ports to which one codeword is mapped. In a case that one codeword is mapped to at least a first layer and a second layer, the UL PTRS may be mapped to the first layer. The UL PTRS may not be mapped to the second layer. The index of the antenna port to which the UL PTRS is mapped may be given at least based on the downlink control information. The downlink physical signals may not be used for transmitting information output from a higher layer, but is used by the physical layer.
Synchronization Signal (SS)
DownLink DeModulation Reference Signal (DL DMRS)
Channel State Information-Reference Signal (CSI-RS)
DownLink Phrase Tracking Reference Signal (DL PTRS)
Tracking Reference Signal (TRS)

The synchronization signal is used for the terminal apparatus 1 to establish synchronization in a frequency domain and/or a time domain in the downlink. The synchronization signal includes a Primary Synchronization Signal (PSS) and a Secondary Synchronization Signal (SSS).

An SS block (SS/PBCH block) is configured to include at least some or all of the PSS, the SSS, and the PBCH. Respective antenna ports of some or all of the PSS, SSS, and PBCH included in the SS block may be the same. Some or all of the PSS, SSS, and PBCH included in the SS block may be mapped to continuous OFDM symbols. Respective CP configurations of some or all of the PSS, SSS, and PBCH included in the SS block may be the same. Respective subcarrier spacing configurations μ of some or all of the PSS, SSS, and PBCH included in the SS block may be the same.

The DL DMRS is associated with transmission of the PBCH, PDCCH and/or PDSCH. The DL DMRS is multiplexed on the PBCH, PDCCH and/or PDSCH. The terminal apparatuses 1 may use the DL DMRS corresponding to the PBCH, PDCCH, or PDSCH in order to perform channel compensation of the PBCH, PDCCH or PDSCH. Hereinafter, transmission of both of the PBCH and the DL DMRS associated with the PBCH is referred to as transmission of the PBCH. Transmission of both of the PDCCH and the DL DMRS associated with the PDCCH is simply referred to as transmission of the PDCCH. Transmission of both of the PDSCH and the DL DMRS associated with the PDSCH is simply referred to as transmission of the PDSCH. The DL DMRS associated with the PBCH is also referred to as a DL DMRS for the PBCH. The DL DMRS associated with the PDSCH is also referred to as a DL DMRS for the PDSCH. The DL DMRS associated with the PDCCH is also referred to as a DL DMRS associated with the PDCCH.

The DL DMRS may be a reference signal individually configured for the terminal apparatus 1. The sequence of the DL DMRS may be given at least based on a parameter individually configured for the terminal apparatus 1. The sequence of the DL DMRS may be given at least based on a UE specific value (e.g., C-RNTI, or the like). The DL DMRS may be individually transmitted for the PDCCH and/or the PDSCH.

The CSI-RS may be a signal at least used to calculate channel state information. A pattern of the CSI-RS assumed by the terminal apparatus may be given by at least a higher layer parameter.

The PTRS may be a signal to be at least used to compensate for phase noise. A pattern of the PTRS assumed by the terminal apparatus may be given at least based on a higher layer parameter and/or DCI.

The DL PTRS may be associated with a DL DMRS group that includes at least an antenna port used for one or multiple DL DMRSs. The association of the DL PTRS with the DL DMRS group may mean that the antenna port for the DL PTRS and some or all of the antenna ports included in the DL DMRS group are at least QCL. The DL DMRS group may be identified at least based on the antenna port of the lowest index of antenna ports for the DL DMRS included in the DL DMRS group.

The TRS may be a signal to be at least used for time and/or frequency synchronization. A pattern of the TRS assumed by the terminal apparatus may be given at least based on a higher layer parameter and/or DCI.

Downlink physical channels and downlink physical signals are collectively referred to as downlink signals. Uplink physical channels and uplink physical signals are collectively referred to as uplink signals. The downlink signals and the uplink physical signals are collectively referred to as physical signals. The downlink signal and the uplink signal are collectively referred to as signals. The downlink physical channels and the uplink physical channels are collectively referred to as physical channels. The downlink physical signals and the uplink physical signals are collectively referred to as physical signals.

In FIG. 1, the following downlink physical channels are used for downlink radio communication from the base station apparatus 3 to the terminal apparatus 1. The downlink physical channels are used by the physical layer for transmission of information output from a higher layer.
Physical Broadcast Channel (PBCH)
Physical Downlink Control Channel (PDCCH)
Physical Downlink Shared Channel (PDSCH)

The PBCH is used at least to transmit the MIB and/or a PBCH payload. The PBCH payload may include at least information indicating an index related to a transmission timing of the SS block. The PBCH payload may include information related to on an identifier (index) of the SS block. The PBCH may be transmitted at a prescribed transmission interval. The PBCH may be transmitted at an interval of 80 ms. The PBCH may be transmitted at an interval of 160 ms. Contents of information included in the PBCH may be updated at every 80 ms. Some or all of the contents of the information included in the PBCH may be updated at every 160 ms. The PBCH may include 288 subcarriers. The PBCH may include 2, 3, or 4 OFDM symbols. The MIB may include information related to an identifier (index) of the SS block. The MIB may include information indicating at least some of a slot number, a subframe number, and/or a radio frame number in which the PBCH is transmitted.

The PDCCH is used at least to transmit the Downlink Control Information (DCI). The PDCCH may be transmitted including at least the downlink control information. The PDCCH may be transmitted including the downlink control information. The downlink control information is also called a DCI format. The downlink control information may indicate at least either a downlink grant or an uplink grant. The DCI format used for scheduling of the PDSCH is also referred to as a downlink DCI format. The DCI format used for scheduling of the PUSCH is also referred to as an uplink DCI format. The downlink grant is also referred to as downlink assignment or downlink allocation. The uplink DCI format includes at least one or both of DCI format 0_0 and DCI format 0_1.

DCI format 0_0 includes at least some or all of 1A to 1F.
1A) DCI format identification field (Identifier for DCI format field)
1B) Frequency domain resource assignment field
1C) Time domain resource assignment field
1D) Frequency hopping flag field
1E) Modulation and Coding Scheme field (MCS field)
1F) First CSI request field

The DCI format identification field may be used at least to indicate whether a DCI format including the DCI format identification field corresponds to any of one or multiple DCI formats. The one or multiple DCI formats may be given at least based on some or all of DCI format 1_0, DCI format 1_1, DCI format 0)0, and/or DCI format 0_1.

The frequency domain resource assignment field may be used at least to indicate frequency resource assignment for the PUSCH scheduled in the DCI format including the frequency domain resource assignment field.

The time domain resource assignment field may be used at least to indicate time resource assignment for the PUSCH scheduled in the DCI format including the time domain resource assignment field.

The frequency hopping flag field may be used at least to indicate whether or not the frequency hopping is applied to the PUSCH scheduled in the DCI format including the frequency hopping flag field.

The MCS field may be used at least to indicate some or all of a modulation scheme and/or target coding rate for the PUSCH scheduled in the DCI format including the MCS field. The target coding rate may be a target coding rate for the transport block of the PUSCH. A size of the transport block (Transport Block Size (TBS)) may be given at least based on the target coding rate.

The first CSI request field is used at least to indicate the CSI report. A size of the first CSI request field may be a prescribed value. The size of the first CSI request field may be 0, 1, 2, or 3.

DCI format 0_1 includes at least some or all of 2A to 2G.
2A) DCI format identification field
2B) Frequency domain resource assignment field
2C) Time domain resource assignment field
2D) Frequency hopping flag field
2E) MCS field
2F) Second CSI request field
2G) BWP field

The BWP field may be used to indicate the uplink BWP to which the PUSCH scheduled in DCI format 0_1 is mapped.

The second CSI request field is used at least to indicate the CSI report. A size of the second CSI request field may be given at least based on a higher layer parameter ReportTriggerSize.

The downlink DCI format includes at least one or both of DCI format 1_0 and DCI format 1_1.

DCI format 1_0 includes at least some or all of 3A to 3H.

3A) DCI format identification field (Identifier for DCI format field)

3B) Frequency domain resource assignment field

3C) Time domain resource assignment field

3D) Frequency hopping flag field

3E) Modulation and Coding Scheme field (MCS field)

3F) First CSI request field

3G) Timing indicator field from PDSCH to HARQ feedback (PDSCH to HARQ feedback timing indicator field)

3H) PUCCH resource indicator field

The PDSCH to HARQ feedback timing indicator field may be a field indicating a timing K1. In a case that the index of the slot including the last OFDM symbol of the PDSCH is a slot n, an index of the slot including the PUCCH or PUSCH including at least the HARQ-ACK corresponding to the transport block included in the PDSCH may be n+K1. In a case that the index of the slot including the last OFDM symbol of the PDSCH is a slot n, an index of the slot including an OFDM symbol at the beginning of the PUCCH or an OFDM symbol at the beginning of the PUSCH including at least the HARQ-ACK corresponding to the transport block included in the PDSCH may be n+K1.

The PUCCH resource indicator field may be a field indicating an index of one or multiple PUCCH resources included in a PUCCH resource set. DCI format 1_1 includes at least some or all of 4A to 4I.
4A) DCI format identification field (Identifier for DCI formats field)
4B) Frequency domain resource assignment field
4C) Time domain resource assignment field
4D) Frequency hopping flag field
4E) Modulation and Coding Scheme field (MCS field)
4F) First CSI request field
4G) Timing indicator field from PDSCH to HARQ feedback (PDSCH to HARQ feedback timing indicator field)
4H) PUCCH resource indicator field
4I) BWP field

The BWP field may be used to indicate the downlink BWP to which the PDSCH scheduled in DCI format 1_1 is mapped.

DCI format 2 may include parameters used for transmission power control of the PUSCH or the PUCCH.

In various aspects of the present embodiment, unless otherwise specified, the number of resource blocks indicates the number of resource blocks in the frequency domain.

A single physical channel may be mapped to a single serving cell. A single physical channel may be mapped to a single carrier bandwidth part configured for a single carrier included in a single serving cell.

The terminal apparatus 1 is provided with one or multiple COntrol REsource SETs (CORESETs). The terminal apparatus 1 monitors the PDCCH in one or multiple control resource sets.

The control resource set may indicate a time-frequency domain to which one or multiple PDCCHs can be mapped. The control resource set may be a domain in which the terminal apparatus 1 monitors the PDCCH. The control resource set may include continuous resources (Localized resources). The control resource set may include non-continuous resources (distributed resources).

In the frequency domain, the unit of mapping the control resource set may use a resource block. In the frequency domain, for example, the unit of mapping the control resource set may be six resource blocks. In the time domain, the unit of mapping the control resource set may use an OFDM symbol. In the time domain, for example, the unit of mapping the control resource set may be one OFDM symbol.

The frequency domain of the control resource sets may be given at least based on higher layer signaling and/or downlink control information.

The time domain of the control resource sets may be given at least based on higher layer signaling and/or downlink control information.

A certain control resource set may be a Common control resource set. The common control resource set may be a control resource set configured commonly to multiple terminal apparatuses 1. The common control resource set may be given at least based on some or all of the MIB, the SIB, the common RRC signaling, and the cell ID. For example, the time resource and/or the frequency resource of the control resource set configured to monitor the PDCCH to be used for scheduling of the SIB may be given at least based on the MIB.

A certain control resource set may be a Dedicated control resource set. The dedicated control resource set may be a control resource set configured to be used exclusively for the terminal apparatus 1. The dedicated control resource set may be given at least based on the dedicated RRC signaling.

A set of PDCCH candidates monitored by the terminal apparatus 1 may be defined from the perspective of a search space. In other words, the set of PDCCH candidates monitored by the terminal apparatus 1 may be given by the search space.

The search space may include one or multiple PDCCH candidates of one or multiple Aggregation levels. The aggregation level for the PDCCH candidate may indicate the number of CCEs constituting the PDCCH.

The terminal apparatus 1 may monitor at least one or multiple search spaces in the slot for which Discontinuous reception (DRX) is not configured. The DRX may be given at least based on a higher layer parameter. The terminal apparatus 1 may monitor at least one or multiple Search space sets in the slot for which the DRX is not configured.

The search space set may include at least one or multiple search spaces. The search space set may be any one of a type 0 PDCCH common search space, a type 0a PDCCH common search space, a type 1 PDCCH common search space, a type 2 PDCCH common search space, a type 3 PDCCH common search space, and/or a UE-specific PDCCH search space.

The type 0 PDCCH common search space, the type 0a PDCCH common search space, the type 1 PDCCH common search space, the type 2 PDCCH common search space, and the type 3 PDCCH common search space are also referred to as a Common Search Space (CSS). The UE-specific PDCCH search space is also referred to as a UE-specific Search Space (USS).

Each search space set may be associated with a single control resource set. Each search space set may be at least included in a single control resource set. Each search space set may be given an index of the control resource set associated with the search space set.

The type 0 PDCCH common search space may be used at least for the DCI format having a Cyclic Redundancy Check (CRC) sequence scrambled with a System Information-Radio Network Temporary Identifier (SI-RNTI). A configuration of the type 0 PDCCH common search space may be given at least based on four bits of Least Significant Bits (LSB) in a higher layer parameter PDCCH-ConfigSIB1. The higher layer parameter PDCCH-ConfigSIB1 may be included in the MIB. The configuration of the type 0 PDCCH common search space may be given at least based on a higher layer parameter SearchSpaceZero. The interpretation of bits in the higher layer parameter SearchSpaceZero may be similar to the interpretation of four bits of the LSB in the higher layer parameter PDCCH-ConfigSIB1. The configuration of the type 0 PDCCH common search space may be given at least based on a higher layer parameter SearchSpaceSIB1. The higher layer parameter SearchSpaceSIB1 may be included in a higher layer parameter PDCCH-ConfigCommon. The PDCCH detected in the type 0 PDCCH common search space may be use at least for scheduling of the PDSCH to be transmitted including an SIB1. The SIB1 is a type of the SIB. The SIB1 may include scheduling information for the SIB other than the SIB1. The terminal apparatus 1 may receive the higher layer parameter PDCCH-ConfigCommon in the EUTRA. The terminal apparatus 1 may receive the higher layer parameter PDCCH-ConfigCommon in the MCG.

The type 0a PDCCH common search space may be used at least for the DCI format having a Cyclic Redundancy Check (CRC) sequence scrambled with a System Information-Radio Network Temporary Identifier (SI-RNTI). The configuration of the type 0a PDCCH common search space may be given at least based on a higher layer parameter SearchSpaceOtherSystemInformation. The higher layer parameter SearchSpaceOtherSystemInformation may be included in the SIB1. The higher layer parameter SearchSpaceOtherSystemInformation may be included in the higher layer parameter PDCCH-ConfigCommon. The PDCCH detected in the type 0 PDCCH common search space may be use at least for scheduling of the PDSCH to be transmitted including an SIB other than the SIB1.

The type 1 PDCCH common search space may be used at least for the DCI format having a CRC sequence scrambled with a Random Access-Radio Network Temporary Identifier (RA-RNTI) and/or a CRC sequence scrambled with a Temporary Common-Radio Network Temporary Identifier (TC-RNTI). The RA-RNTI may be given at least based on a time/frequency resource of the random access preamble transmitted by the terminal apparatus 1. The TC-RNTI may be given by a PDSCH that is scheduled in the DCI format having the CRC sequence scrambled with the RA-RNTI (also referred to as a message 2 or a random access response grant). A configuration of the type 1 PDCCH common search space may be given at least based on a higher layer parameter ra-SearchSpace. The higher layer parameter ra-SearchSpace may be included in the SIB1. The higher layer parameter ra-SearchSpace may be included in the higher layer parameter PDCCH-ConfigCommon. The type 2 PDCCH common search space may be used at least for the DCI format having a CRC sequence scrambled with a Paging-Radio Network Temporary Identifier (P-RNTI). The P-RNTI may be used at least to transmit the DCI format including information notifying an SIB change. A configuration of the type 2 PDCCH common search space may be given at least based on a higher layer parameter PagingSearchSpace. The higher layer parameter PagingSearchSpace may be included in the SIB1. The higher layer parameter PagingSearchSpace may be included in the higher layer parameter PDCCH-ConfigCommon.

The type 3 PDCCH common search space may be used at least for the DCI format having a CRC sequence scrambled with a Cell-Radio Network Temporary Identifier (C-RNTI). The C-RNTI may be given at least based on a PDSCH that is scheduled in the DCI format having the CRC sequence scrambled with the TC-RNTI (also referred to as a message 4 or a contention resolution). The type 3 PDCCH common search space may be a search space set that is given in a case that a higher layer parameter SearchSpaceType is set in common.

The UE-specific PDCCH search space may be used at least for the DCI format having the CRC sequence scrambled with the C-RNTI.

In a case that the C-RNTI is provided to the terminal apparatus 1, the type 0 PDCCH common search space, the type 0a PDCCH common search space, the type 1 PDCCH common search space, and/or the type 2 PDCCH common search space may be at least used for the DCI format having the CRC sequence scrambled with the C-RNTI.

In the case that the C-RNTI is provided to the terminal apparatus 1, the search space set that is given at least based on any one of the higher layer parameter PDCCH-ConfigSIB1, the higher layer parameter SearchSpaceZero, the higher layer parameter SearchSpaceSIB1, the higher layer parameter SearchSpaceOtherSystemInformation, the higher layer parameter ra-SearchSpace or the higher layer parameter PagingSearchSpace may be used at least for the DCI format having the CRC sequence scrambled with the C-RNTI.

The common control resource set may include at least one or both of the CSS and the USS. The dedicated control resource set may include at least one or both of the CSS and the USS.

A physical resource of the search space includes a Control Channel Element (CCE) of the control channel. The CCE includes six resource element groups (REGs). The REG may include one OFDM symbol in one Physical Resource Block (PRB). In other words, the REG may include 12 Resource Elements (REs). The PRB is also simply referred to as a Resource Block (RB).

The PDSCH is used at least to transmit the transport block. The PDSCH may be used at least to transmit a random access message 2 (random access response). The PDSCH may be used at least to transmit system information including parameters used for an initial access.

The BCH, UL-SCH, and DL-SCH described above are transport channels. A channel used in a Medium Access Control (MAC) layer is referred to as a transport channel. A unit of the transport channel used in the MAC layer is also referred to as a transport block or a MAC PDU. A Hybrid Automatic Repeat reQuest (HARD) is controlled for each transport block in the MAC layer. The transport block is a unit of data that the MAC layer delivers to the physical layer. In the physical layer, the transport block is mapped to a codeword, and a modulation process is performed for each codeword.

The base station apparatus 3 and the terminal apparatus 1 may exchange (transmit and/or receive) signals in the higher layer. For example, the base station apparatus 3 and the terminal apparatus 1 may transmit and/or receive Radio Resource Control (RRC) signaling (also referred to as a Radio Resource Control (RRC) message or Radio Resource Control (RRC) information) in an RRC layer. Furthermore, the base station apparatus 3 and the terminal apparatus 1 may transmit and/or receive, in the MAC layer, a MAC Control Element (CE). Here, the RRC signaling and/or the MAC CE is also referred to as higher layer signaling.

The PUSCH and the PDSCH are at least used to transmit the RRC signaling and the MAC CE. Here, the RRC signaling transmitted from the base station apparatus 3 on the PDSCH may be RRC signaling common to multiple terminal apparatuses 1 in a cell. The RRC signaling common to the multiple terminal apparatuses 1 in the cell is also referred to as common RRC signaling. The RRC signaling transmitted from the base station apparatus 3 on the PDSCH may be RRC signaling dedicated to a certain terminal apparatus 1 (which is also referred to as dedicated signaling or UE specific signaling). The RRC signaling dedicated to the terminal apparatus 1 is also referred to as dedicated RRC signaling. A cell specific parameter may be transmitted using the RRC signaling common to the multiple terminal apparatuses 1 in the cell or the RRC signaling dedicated to the certain terminal apparatus 1. A UE specific parameter may be transmitted using the RRC signaling dedicated to the certain terminal apparatus 1.

The base station apparatus 3 and the terminal apparatus 1 exchange (transmit and/or receive) higher layer signaling in the higher layer. For example, the base station apparatus 3 and the terminal apparatus 1 may transmit and/or receive Radio Resource Control (RRC) signaling (Radio Resource Control (RRC) message or Radio Resource Control (RRC) information) in an RRC layer. Furthermore, the base station apparatus 3 and the terminal apparatus 1 may transmit and/or receive, in the MAC layer, a MAC Control Element (CE). Here, the RRC signaling and/or the MAC CE is also referred to as higher layer signaling.

A Broadcast Control CHannel (BCCH), a Common Control CHannel (CCCH), and a Dedicated Control CHannel (DCCH) are logical channels. For example, the BCCH is a higher layer channel used to transmit the MIB. Furthermore, the Common Control CHannel (CCCH) is a higher layer channel used to transmit information common to the multiple terminal apparatuses 1. Here, the CCCH may be used for a terminal apparatus 1 that is not in an RRC connected state, for example. Furthermore, the Dedicated Control CHannel (DCCH) may be a higher layer channel at least used to transmit control information dedicated to the terminal apparatus 1 (dedicated control information). Here, the DCCH is used for a terminal apparatus 1 that is in an RRC connected state, for example.

The BCCH in the logical channel may be mapped to the BCH, the DL-SCH, or the UL-SCH in the transport channel. The CCCH in the logical channel may be mapped to the DL-SCH or the UL-SCH in the transport channel. The DCCH in the logical channel may be mapped to the DL-SCH or the UL-SCH in the transport channel.

The UL-SCH in the transport channel may be mapped to the PUSCH in the physical channel. The DL-SCH in the transport channel may be mapped to the PDSCH in the physical channel. The BCH in the transport channel may be mapped to the PBCH in the physical channel.

Configurations of apparatuses according to the present embodiment will be described below.

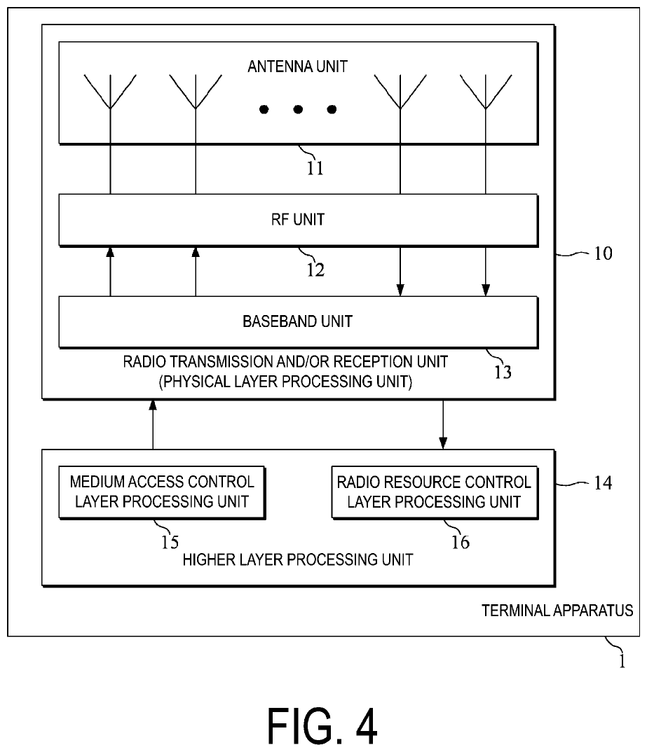

FIG. 4 is a schematic block diagram illustrating a configuration of the terminal apparatus 1 according to the present embodiment. As illustrated, the terminal apparatus 1 is configured to include a radio transmission and/or reception unit 10 and a higher layer processing unit 14. The radio transmission and/or reception unit 10 is configured to include an antenna unit 11, a Radio Frequency (RF) unit 12, and a baseband unit 13. The higher layer processing unit 14 is configured to include a medium access control layer processing unit 15 and a radio resource control layer processing unit 16. The radio transmission and/or reception unit 10 is also referred to as a transmitter, a receiver, a coding unit, a decoding unit, or a physical layer processing unit.

The higher layer processing unit 14 outputs uplink data (transport block) generated by a user operation or the like, to the radio transmission and/or reception unit 10. The higher layer processing unit 14 performs processing of the Medium Access Control (MAC) layer, the Packet Data Convergence Protocol (PDCP) layer, the Radio Link Control (RLC) layer, and the Radio Resource Control (RRC) layer.

The medium access control layer processing unit 15 included in the higher layer processing unit 14 performs processing of the Medium Access Control layer. The medium access control layer processing unit 15 controls random access procedure in accordance with various types of configuration information/parameters managed by the radio resource control layer processing unit 16.

The radio resource control layer processing unit 16 included in the higher layer processing unit 14 performs processing of the Radio Resource Control layer. The radio resource control layer processing unit 16 manages various types of configuration information/parameters of the terminal apparatus 1. The radio resource control layer processing unit 16 sets various types of configuration information/parameters based on a higher layer signaling received from the base station apparatus 3. Namely, the radio resource control layer processing unit 16 sets the various configuration information/parameters in accordance with the information for indicating the various configuration information/parameters received from the base station apparatus 3.

The radio transmission and/or reception unit 10 performs processing of the physical layer, such as modulation, demodulation, coding, decoding, and the like. The radio transmission and/or reception unit 10 demultiplexes, demodulates, and decodes a signal received from the base station apparatus 3, and outputs the information resulting from the decoding to the higher layer processing unit 14. The radio transmission and/or reception unit 10 generates a transmit signal by modulating and coding data, and performs transmission to the base station apparatus 3.

The RF unit 12 converts (down-converts) a signal received via the antenna unit 11 into a baseband signal by orthogonal demodulation, and removes unnecessary frequency components. The RF unit 12 outputs a processed analog signal to the baseband unit.

The baseband unit 13 converts the analog signal input from the RF unit 12 into a digital signal. The baseband unit 13 removes a portion corresponding to a Cyclic Prefix (CP) from the digital signal resulting from the conversion, performs Fast Fourier Transform (FFT) of the signal from which the CP has been removed, and extracts a signal in the frequency domain.

The baseband unit 13 generates an SC-FDMA symbol by performing Inverse Fast Fourier Transform (IFFT) of the data, adds CP to the generated SC-FDMA symbol, generates a baseband digital signal, and converts the baseband digital signal into an analog signal. The baseband unit 13 outputs the converted analog signal to the RF unit 12.

The RF unit 12 removes unnecessary frequency components from the analog signal input from the baseband unit 13 by using a low-pass filter, up-converts the analog signal into a signal of a carrier frequency, and transmits the up-converted signal via the antenna unit 11. Furthermore, the RF unit 12 amplifies power. Furthermore, the RF unit 12 may have a function of controlling transmit power. The RF unit 12 is also referred to as a transmit power control unit.

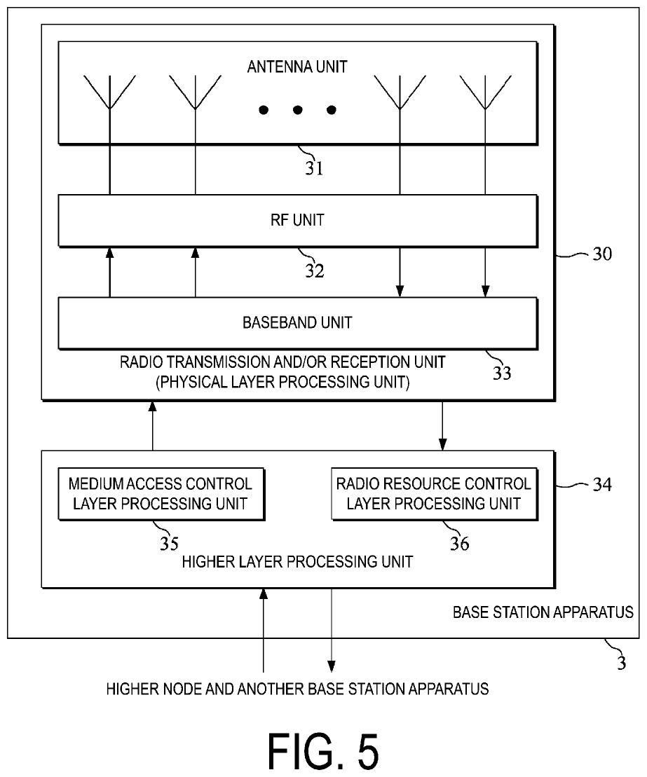

FIG. 5 is a schematic block diagram illustrating a configuration of the base station apparatus 3 according to the present embodiment. As illustrated, the base station apparatus 3 is configured to include a radio transmission and/or reception unit 30 and a higher layer processing unit 34. The radio transmission and/or reception unit 30 is configured to include an antenna unit 31, an RF unit 32, and a baseband unit 33. The higher layer processing unit 34 is configured to include a medium access control layer processing unit 35 and a radio resource control layer processing unit 36. The radio transmission and/or reception unit 30 is also referred to as a transmitter, a receiver, a coding unit, a decoding unit, or a physical layer processing unit.

The higher layer processing unit 34 performs processing of the Medium Access Control (MAC) layer, the Packet Data Convergence Protocol (PDCP) layer, the Radio Link Control (RLC) layer, and the Radio Resource Control (RRC) layer.

The medium access control layer processing unit 35 included in the higher layer processing unit 34 performs processing of the Medium Access Control layer. The medium access control layer processing unit 35 controls random access procedure in accordance with various types of configuration information/parameters managed by the radio resource control layer processing unit 36.

The radio resource control layer processing unit 36 included in the higher layer processing unit 34 performs processing of the Radio Resource Control layer. The radio resource control layer processing unit 36 generates, or acquires from a higher node, downlink data (transport block) allocated on a physical downlink shared channel, system information, an RRC message, a MAC Control Element (CE), and the like, and performs output to the radio transmission and/or reception unit 30. Furthermore, the radio resource control layer processing unit 36 manages various types of configuration information/parameters for each of the terminal apparatuses 1. The radio resource control layer processing unit 36 may set various types of configuration information/parameters for each of the terminal apparatuses 1 via higher layer signaling. That is, the radio resource control layer processing unit 36 transmits/reports information indicating various types of configuration information/parameters.

The functionality of the radio transmission and/or reception unit 30 is similar to the functionality of the radio transmission and/or reception unit 10, and hence description thereof is omitted.

Each of the units having the reference signs 10 to 16 included in the terminal apparatus 1 may be configured as a circuit. Each of the units having the reference signs 30 to 36 included in the base station apparatus 3 may be configured as a circuit. Each of the units that are included in the terminal apparatus 1 and have the reference signs 10 to 16 may be configured as at least one processor and a memory coupled to the at least one processor. Each of the units that are included in the base station apparatus 3 and have the reference signs 30 to 36 may be configured as at least one processor and a memory coupled to the at least one processor.

Time Division Duplex (TDD) and/or Frequency Division Duplex (FDD) may be applied to a radio communication system according to the present embodiment. In a case of a cell aggregation, serving cells to which TDD is applied and serving cells to which FDD is applied may be aggregated.

Note that, the higher layer signaling may be any one of Remaining Minimum System Information (RMSI), Other System Information (OSI), System Information Block (SIB), a Radio Resource Control (RRC) message, and a Medium Access Control (MAC) Control Element (CE). Furthermore, a higher layer parameter may refer to a parameter or information element included in higher layer signaling.

The UCI transmitted on the PUCCH may include a HARQ-ACK, a scheduling request, and/or CSI.

The terminal apparatus 1 configures a resource (PUCCH resource) for PUCCH transmission in a PUCCH format, based on one or multiple higher layer parameters. A higher layer parameter PUCCH-resource-config-PF0 is used to configure one or multiple PUCCH resources for PUCCH transmission in PUCCH format 0. A higher layer parameter PUCCH-resource-config-PF1 is used to configure one or multiple PUCCH resources for PUCCH transmission in PUCCH format 1. A higher layer parameter PUCCH-resource-config-PF2 is used to configure one or multiple PUCCH resources for PUCCH transmission in PUCCH format 2. A higher layer parameter PUCCH-resource-config-PF3 is used to configure one or multiple PUCCH resources for PUCCH transmission in PUCCH format 3. A higher layer parameter PUCCH-resource-config-PF4 is used to configure one or multiple PUCCH resources for PUCCH transmission in PUCCH format 4.

Here, the PUCCH format may be defined at least based on a value and type of the higher layer parameter used for the PUCCH resource configuration corresponding to the PUCCH format, and/or the number of UCI bits that can be transmitted on the PUCCH resource corresponding to the PUCCH format. For example, PUCCH format 0 may have a length of one or two OFDM symbols, and the number of UCI bits may be one or two bits. PUCCH format 1 may have a length of equal to or larger than four OFDM symbols, and the number of UCI bits may be one or two bits. PUCCH format 2 may have a length of one or two OFDM symbols, and the number of UCI bits may be equal to or larger than 3. PUCCH format 3 may have a length of equal to or larger than four OFDM symbols, and the number of UCI bits may be equal to or larger than three. PUCCH format 4 may have a length of equal to or larger than four OFDM symbols, and the number of UCI bits may be equal to or larger than three. The PUCCH resource configured in PUCCH format 4 may include an OCC.

One or multiple PUCCH resource sets may be configured by a higher layer parameter PUCCH-resource-set. The terminal apparatus 1 may configure the number of PUCCH resources included in one PUCCH resource set by a higher layer parameter PUCCH-resource-set-size. The terminal apparatus 1 may determine the PUCCH resource set in accordance with the number A of UCI bits. In a case that the number A of UCI bits is equal to or smaller than N₁, the terminal apparatus 1 determines a first PUCCH resource set. In a case that the number A of UCI bits is larger than N₁ and is equal to or smaller than N₂, the terminal apparatus 1 determines a second PUCCH resource set. In a case that the number A of UCI bits is equal to or larger than N₂ and equal to or smaller than N₃, the terminal apparatus 1 determines a third PUCCH resource set. In a case that the number A of UCI bits is equal to or larger than N₃ and equal to or smaller than N₄, the terminal apparatus 1 determines a fourth PUCCH resource set. N₁ may be 2. N₂, N₃, and N₄ may be configured by the higher layer parameters.

In a case that the terminal apparatus 1 is not configured with the higher layer parameter PUCCH-resource-set for configuring the PUCCH resource set, the uplink BWP for PUCCH transmission with the HARQ-ACK information is indicated by SystemInformationBlockType1, and the PUCCH resource set is indicated by a higher layer parameter PUCCH-resource-common included in SystemInformationBlockType1.

In order for the terminal apparatus 1 to transmit the HARQ-ACK information using the PUCCH, the terminal apparatus 1 determines the PUCCH resource after determining the PUCCH resource set. The determination of the PUCCH resource is performed at least based on a value of a PUCCH resource indicator field included in a DCI format 1_0 or DCI format 1_1 last detected by the terminal apparatus 1.

The terminal apparatus 1 transmits, on the PUCCH, the HARQ-ACK information corresponding to an order indicated by the detected DCI format 1_0 or DCI format 1_1. The order of the detected DCI format 1_0 or DCI format 1_1 is configured first with indexes between the cells in ascending order, and thereafter, with a PDCCH monitoring occasion. For example, in a case that the terminal apparatus 1 detects, in a serving cell 1, a DCI format A at a PDCCH monitoring occasion T and a DCI format B at a PDCCH monitoring occasion (T+1), and detects, in a serving cell 2, a DCI format C at the PDCCH monitoring occasion T and a DCI format D at a the PDCCH monitoring occasion (T+1), the terminal apparatus 1 transmits the HARQ-ACK information corresponding to each DCI format on the PUCCH in the order of the DCI format A, the DCI format C, the DCI format B, and the DCI format D. Here, the DCI format A, the DCI format B, the DCI format C, and DCI format D may be the DCI format of at least the DCI format 1_0 or the DCI format 1_1.

The terminal apparatus 1 performs mapping to a PUCCH resource index configured by a higher layer parameter PUCCH-resource-index indicated by a value of the PUCCH resource indicator field included in the DCI format 1_0 or DCI format 1_1 detected from the PDCCH. The PUCCH resource index is an index of each of one or multiple PUCCH resources configured by the higher layer parameter PUCCH-resource-set-size. For example, four PUCCH resources are configured by the higher layer parameter PUCCH-resource-set-size in a certain PUCCH resource set, and a relationship between the value of the PUCCH resource indicator field and the PUCCH resource is configured by the higher layer parameter PUCCH-resource-index such that a PUCCH resource corresponding to a value of 00 of the PUCCH resource indicator field is the first PUCCH resource, a PUCCH resource corresponding to a value of 01 of the PUCCH resource indicator field is the second PUCCH resource, a PUCCH resource corresponding to a value of 10 of the PUCCH resource indicator field is the third PUCCH resource, and a PUCCH resource corresponding to a value of 11 of the PUCCH resource indicator field is the fourth PUCCH resource, and then, in a case that the value of the PUCCH resource indicator field included in the DCI format 1_0 or DCI format 1_1 detected from the PDCCH by the terminal apparatus 1 is 10, the terminal apparatus 1 selects the third PUCCH resource.

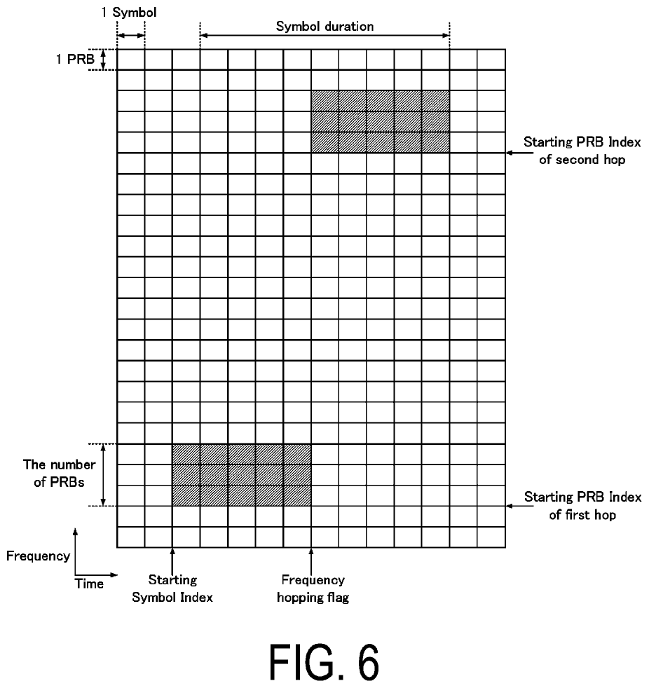

FIG. 6 is a diagram illustrating an example in which a PUCCH resource is configured by higher layer parameters according to the present embodiment. One PUCCH resource set may be configured with one or multiple PUCCH resources. Each PUCCH resource may be provided at least based on, as illustrated in FIG. 6, some or all of a starting symbol index from which the PUCCH is mapped, the number of symbols (symbol duration), a starting PRB index of first hop in a case with or without frequency hopping, a starting PRB index of second hop in a case with frequency hopping, the number of PRBs, a frequency hopping flag, a cyclic shift index, and an OCC index. The multiple PUCCH resources configured to one PUCCH resource set may be indexed by a smaller index as the number of PRBs is smaller. Specifically, a PUCCH resource 1 may have the number of PRBs fewer than or the same as a PUCCH resource 2. Here, the PRB is also referred to as a bandwidth or an RB.

PUCCH format 0 may be given by a higher layer parameter PUCCH-format0, at least based on some or all of a starting symbol index, a symbol duration, a frequency hopping flag, a first hop in a case with frequency hopping and/or a starting PRB index in a case without frequency hopping, a starting PRB index of second hop in a case with frequency hopping, and a cyclic shift index.

PUCCH format 1 may be given by a higher layer parameter PUCCH-format1, at least based on some or all of a starting symbol index, a symbol duration, a frequency hopping flag, a first hop in a case with frequency hopping and/or a starting PRB index in a case without frequency hopping, a starting PRB index of second hop in a case with frequency hopping, a cyclic shift index, and an OCC index.

PUCCH format 2 may be given by a higher layer parameter PUCCH-format2, at least based on some or all of a starting symbol index, a symbol duration, a frequency hopping flag, a first hop in a case with frequency hopping and/or a starting PRB index in a case without frequency hopping, a starting PRB index of second hop in a case with frequency hopping, and the number of PRBs.

PUCCH format 3 may be given by a higher layer parameter PUCCH-format3, at least based on some or all of a starting symbol index, a symbol duration, a frequency hopping flag, a first hop in a case with frequency hopping and/or a starting PRB index in a case without frequency hopping, a starting PRB index of second hop in a case with frequency hopping, and the number of PRBs.

PUCCH format 4 may be given by a higher layer parameter PUCCH-format4, at least based on some or all of a starting symbol index, a symbol duration, a frequency hopping flag, a first hop in a case with frequency hopping and/or a starting PRB index in a case without frequency hopping, a starting PRB index of second hop in a case with frequency hopping, an OCC length, and an OCC index.

In PUCCH format 1, PUCCH format 3, and/or, PUCCH format 4, the terminal apparatus 1 may configure one or multiple slots at least based on a higher layer parameter nrofSlots for PUCCH transmission. nrofSlots may be N_{PUCCH}^{repeat}. N_{PUCCH}^{repeat} may be 1, 2, 4, or 8. The terminal apparatus 1 configuring N_{PUCCH}^{repeat} slots for PUCCH transmission may mean that the terminal apparatus 1 repeats the PUCCH transmission including the UCI in N_{PUCCH}^{repeat} slots.

In the present embodiment, the terminal apparatus 1 repeating the PUCCH transmission in two or more slots (i.e., N_{PUCCH}^{repeat}<1) is referred to as multi-slot PUCCH transmission.

The terminal apparatus 1 may repeat the PUCCH transmission including the UCI in N_{PUCCH}^{repeat} slots. Here, the terminal apparatus 1 may use PUCCH format 1, PUCCH format 3, or PUCCH format 4 for repeated PUCCH transmission. In a case that the higher layer parameter nrofSlots is configured, N_{PUCCH}^{repeat} may be given at least based on the higher layer parameter nrofSlots. In a case that the higher layer parameter nrofSlots is not configured, N_{PUCCH}^{repeat} may be 1.

In a case that the terminal apparatus 1 repeats the PUCCH transmission including the UCI in N_{PUCCH}^{repeat} slots, the PUCCH transmissions in the respective slots included in N_{PUCCH}^{repeat} slots may have the same number of consecutive symbols. In the case of PUCCH format 1, the number of consecutive symbols may be given at least based on nrofSymbols included in a higher layer parameter PUCCH-format1. In the case of PUCCH format 3, the number of consecutive symbols may be given at least based on nrofSymbols included in a higher layer parameter PUCCH-format3. In the case of PUCCH format 4, the number of consecutive symbols may be given at least based on nrofSymbols included in a higher layer parameter PUCCH-format4. That is, in each slot included in N_{PUCCH}^{repeat} slots, the number of symbols used for PUCCH transmission may be the same.

In the case that the terminal apparatus 1 repeats the PUCCH transmission including the UCI in N_{PUCCH}^{repeat} slots, the starting symbol indexes for the PUCCH transmissions in the respective slots included in N_{PUCCH}^{repeat} slots may be the same. In the case of PUCCH format 1, the starting symbol index may be given at least based on startingSymbollndex included in the higher layer parameter PUCCH-format1. . In the case of PUCCH format 3, the starting symbol index may be given at least based on startingSymbollndex included in the higher layer parameter PUCCH-format3. In the case of PUCCH format 4, the starting symbol index may be given at least based on startingSymbollndex included in the higher layer parameter PUCCH-format4.

In a case that a higher layer parameter interslotFrequencyHopping is given to the terminal apparatus 1, the terminal apparatus 1 may perform frequency hopping for PUCCH transmission in different slots. In the case that the higher layer parameter interslotFrequencyHopping is given to the terminal apparatus 1, the frequency hopping may be performed in slot units. In the case that the higher layer parameter interslotFrequencyHopping is given to the terminal apparatus 1, the terminal apparatus 1 may transmit a PUCCH starting from a first PRB indicated at least based on a higher layer parameter startingPRB in an even-numbered slot. In the case that the higher layer parameter interslotFrequencyHopping is given to the terminal apparatus 1, the terminal apparatus 1 may transmit a PUCCH starting from a second PRB indicated at least based on a higher layer parameter secondHopPRB in an odd-numbered slot. Here, the terminal apparatus 1 and the base station apparatus 3 may determine the first slot for transmitting a PUCCH as 0, and, with or without PUCCH transmission, continuously apply the slot numbers to N_{PUCCH}^{repeat} slots, and then, determine the odd-numbered slot and the even-numbered slot at least based on the slot numbers. Here, the 0-th slot may be considered as an even-numbered slot. In the case that the higher layer parameter interslotFrequencyHopping is given to the terminal apparatus 1, the terminal apparatus 1 may not expect that the frequency hopping is configured to be performed for PUCCH transmission in one slot.

In a case that the higher layer parameter interslotFrequencyHopping is not given to the terminal apparatus 1, and that the terminal apparatus 1 is configured to perform the frequency hopping for PUCCH transmission in one slot, frequency hopping patterns in the first PRB and the second PRB may be the same in the respective slots. The first PRB may be given at least based on the higher layer parameter startingPRB. The second PRB may be given at least based on the higher layer parameter secondHopPRB.

The terminal apparatus 1 being given the higher layer parameter interslotFrequencyHopping in a multi-slot PUCCH transmission may mean that the terminal apparatus 1 may perform the frequency hopping in different slots. The terminal apparatus 1 not being given the higher layer parameter interslotFrequencyHopping in a PUCCH transmission may mean that the terminal apparatus 1 may not perform the frequency hopping in different slots.

In a case that the number of symbols capable of PUCCH transmission in one slot in the multi-slot PUCCH transmission is smaller than a value given by the higher layer parameter nrofSlots, the terminal apparatus 1 may not transmit the PUCCH in the slot. The higher layer parameter nrofSlots may be given in the PUCCH format corresponding to the PUCCH transmission.

In a case that the terminal apparatus 1 is given TDD-UL-DL-ConfigurationCommon and is not given TDD-UL-DL-ConfigDedicated, or in a case that the terminal apparatus 1 is given both TDD-UL-DL-ConfigurationCommon and TDD-UL-DL-ConfigDedicated, the terminal apparatus 1 may determine N_{PUCCH}^{repeat} second slots in which the multi-slot PUCCH transmission start, from a first slot given to the terminal apparatus 1. Here, in a case that the PUCCH format used in the multi-slot PUCCH transmission is PUCCH format 1, the second slot may be configured with the starting symbol that is given by startingSymbollndex included in the higher layer parameter PUCCH-format1. . In a case that the PUCCH format used in the multi-slot PUCCH transmission is PUCCH format 3, the second slot may be configured with the starting symbol that is given by startingSymbollndex included in the higher layer parameter PUCCH-format3. In a case that the PUCCH format used in the multi-slot PUCCH transmission is PUCCH format 4, the second slot may be configured with the starting symbol that is given by startingSymbollndex included in the higher layer parameter PUCCH-format4. Here, the starting symbol may be an uplink symbol or a flexible symbol.

In a case that the terminal apparatus 1 is not given TDD-UL-DL-ConfigurationCommon, the terminal apparatus 1 determines N_{PUCCH}^{repeat} slots for PUCCH transmission. Here, N_{PUCCH}^{repeat} slots may be N_{PUCCH}^{repeat} slots consecutive from a starting slot given to the terminal apparatus 1.

In a case that the terminal apparatus 1 transmits a PUCCH in the first N_{PUCCH}^{repeat} slots, N_{PUCCH}^{repeat} being larger than one, and the terminal apparatus 1 transmits a PUSCH in one or multiple slots, and the PUCCH transmission overlaps a PUSCH transmission in one or multiple slots, and a processing timeline requirement for the PUCCH transmission and a processing timeline requirement for the PUSCH transmission are satisfied, the terminal apparatus 1 may transmit the PUCCH in the slot where the PUSCH and the PUCCH are overlapped, and may not transmit the PUSCH.

In a case that a time from a symbol T_{PUSCH, 0} to a symbol T_{PUSCH, 1} is greater than or equal to a prescribed time T_{proc}, the processing timeline requirement for the PUSCH transmission is satisfied. The prescribed time T_{proc} may be given based on the downlink subcarrier spacing and/or the uplink subcarrier spacing. For example, T_{PUSCH, O} may be a time point of completing reception of the last symbol in one or multiple symbols for receiving the PDCCH including the DCI format for scheduling the PUSCH. For example, T_{PUSCH, 1} may be a time point of starting transmission of the first symbol in one or multiple symbols for transmitting the PUSCH.

The processing timeline requirement for the PUCCH transmission may be a time from the symbol T_{PUCCH, 0} to the symbol T_{PUCCH, 1}. In a case that the UCI transmitted on the PUCCH is a HARQ-ACK, T_{PUCCH, 0} may be a time point of completing reception of the last symbol in one or multiple symbols in the reception of some or all of the PDSCH or SPS PDSCH or SPS PDSCH release corresponding to the HARQ-ACK. T_{PUCCH, 1} may be a time point of starting transmission of the first symbol in one or multiple symbols for transmitting the PUCCH.

The time T_{proc} may be T_{proc, 1}, T_{proc, 2}, or T_{proc, 3}.

T_{proc, 1} may indicate a time requirement for processing of the PDSCH performed in the terminal apparatus 1 (channel estimation, channel compensation, demodulation, spatial processing, and/or decoding processing, and the like). T_{proc, 1} may be given based at least on some or all of N₁, d_{1, 1}, κ, μ, and T_{c}. For example, T_{proc, 1} may be given by T_{proc, 1}=(N₁+d_{1, 1}) (2048+144)*κ2^{-μ}*T_{c}. N₁ may be given at least based on one or both of the processing capability of the terminal apparatus 1 associated with the PDSCH and/or the subcarrier spacing configuration Here, the subcarrier spacing configuration μ related to the calculation of T_{proc, 1} is given from a set of subcarrier spacing configurations μ associated with the PDSCH. The set of subcarrier spacing configurations μ associated with the PDSCH is configured to include some or all of μ_{PDCCH_DL}, μ_{PDSCH}, and/or μ_{UL}. The selected subcarrier spacing configuration μ corresponds to the largest T_{proc, 1} of T_{proc, 1} corresponding to each of the set of subcarrier spacing configurations μ associated with the PDSCH. Here, the μ_{PDCCH_DL} may be the subcarrier spacing configuration μ to be applied to the PDCCH to be used for scheduling of the PDSCH. μ_{PDSCH} may be a subcarrier spacing configuration μ applied to the PDSCH. μ_{UL}, may be a subcarrier spacing configuration to be applied to the uplink physical channel on which the HARQ-ACK is multiplexed. That is, μ_{UL} may be a subcarrier spacing configuration μ to applied to the PUCCH.

T_{proc, 2} may indicate a time requirement for processing of the PDSCH performed in the terminal apparatus 1 and a time requirement for the UCI transmission processing. T_{proc, 2} may be given based at least on some or all of N₁, d_{1, 1}, κ, μ, and T_{c}. For example, T _{proc, 2} may be T_{proc, 2}=(N₁+d_{1, 1}+1) (2048+144)*κ2^{-μ}*T_{c}. Here, the subcarrier spacing configuration μ related to the calculation of T_{proc, 2} is selected from a set of subcarrier spacing configurations μ associated with the PDSCH. The set of subcarrier spacing configurations μ associated with the PDSCH is configured to include some or all of μ_{PDCCH_DL}, μ_{PDSCH}, and/or μ_{X}. The selected subcarrier spacing configuration μ may correspond to the largest T_{proc, 2} of T_{proc, 2} corresponding to each of the set of subcarrier spacing configurations μ associated with the PDSCH. The selected subcarrier spacing configuration μ may correspond to a subcarrier spacing configuration μ where the subcarrier spacing is the smallest subcarrier spacing among the set of subcarrier spacing configurations μ associated with the PDSCH. Here, the μ_{PDCCH_DL} may be the subcarrier spacing configuration μ to be applied to the PDCCH to be used for scheduling of the PDSCH. μ_{PDSCH} may be a subcarrier spacing configuration μ applied to the PDSCH. μₓ may be given from the subcarrier spacing configurations μ corresponding to respective uplink physical channels included in a resource set X. μ_{X} may correspond to the largest T_{proc, 2} in the subcarrier spacing configurations μ corresponding to the respective uplink physical channels included in the resource set X. μ_{X} may correspond to the configuration μ where the subcarrier spacing is the smallest subcarrier spacing among the subcarrier spacing configurations μ corresponding to the respective uplink physical channels included in the resource set X.

T_{proc, 3} may indicate a time requirement for processing of the PUSCH performed in the terminal apparatus 1 (coding, precoding, and/or generating in a baseband signal, and the like) and a time requirement for the UCI transmission processing. T_{proc, 3} may be given based at least on some or all of N₂, d_{2, 1}, d_{2, 2}, κ, μ, and T_{c}. For example, T_{proc, 3} may be T_{proc, 3}=max(((N₂+d_{2, 1}+1) (2048+144)*κ2^{-μ})*T_{c}, d_{2, 2}). For example, T_{proc, 3} may be T_{proc, 3}=((N₂+d_{2, 1}+1) (2048+144)*κ2^{-μ})*T_{c}. N₂ may be given at least based on the processing capability of the terminal apparatus 1 associated with the PUSCH and/or the subcarrier spacing configuration Here, the subcarrier spacing configuration μ related to the calculation of T_{proc, 3} is selected from a first set of subcarrier spacing configurations μ associated with the PUSCH. The first set of subcarrier spacing configurations μ associated with the PUSCH is configured to include some or all of μ_{PDCCH_UL} and/or μ_{X}. The selected subcarrier spacing configuration μ may correspond to the largest T_{proc, 3} of T_{proc, 3} corresponding to each of the first set of subcarrier spacing configurations μ associated with the PUSCH. The selected subcarrier spacing configuration μ may correspond to a subcarrier spacing configuration μ where the subcarrier spacing is the smallest subcarrier spacing among the first set of subcarrier spacing configurations μ associated with PUSCH. Here, μ_{PDCCH_UL} may be a subcarrier spacing configuration μ applied to the PDCCH.

d_{2, 1} may be 0 in a case that an OFDM symbol at the beginning of the PUSCH is constituted only by DMRS. d_{2, 1} may be 1 in a case that an OFDM symbol at the beginning of the PUSCH is not constituted only by DMRS. The OFDM symbol at the beginning of the PUSCH being not constituted only by DMRS may be the OFDM symbol at the beginning of the PUSCH not being constituted by DMRS. The OFDM symbol at the beginning of the PUSCH being not constituted only by DMRS may be the OFDM symbol at the beginning of the PUSCH being constituted by DMRS and uplink data demodulation symbols.

d_{2, 2} may correspond to a processing timeline related to a switch of the BWP triggered by the DCI.

In the case of PUCCH transmission in an N_{PUCCH}^{repeat} slots N_{PUCCH}^{repeat} being larger than one, the terminal apparatus 1 may not multiplex the different UCI.

In a case that the terminal apparatus 1 transmit a first PUCCH in a first number N_{PUCCH}^{repeat, 1} of slots, N_{PUCCH}^{repeat, 1} being larger than one, and the terminal apparatus 1 transmit a second PUCCH in a second number N_{PUCCH}^{repeat, 2} of slots, N_{PUCCH}^{repeat, 2} being equal to or larger than one, and the first PUCCH the second PUCCH are overlapped in a third number N_{PUCCH}^{repeat, 3} of slots, the terminal apparatus 1 may perform operations (1) to (3) below. In the operations (1) to (3), a priority may be in the order of HARQ-ACK>SR>CSI with a higher priority >CSI with a lower priority. The priority for HARQ-ACK may be the highest.
Operation (1): The terminal apparatus 1 may not expect that the first PUCCH and the second PUCCH start transmission in the same slot.
Operation (2): In a case that the UCI included in the first PUCCH and the second PUCCH have the same priority, the terminal apparatus 1 may transmit the PUCCH that is earlier in a transmission start and may not transmit the PUCCH that is later in a transmission start.
Operation (3): In a case that the UCI included in the first PUCCH and the second PUCCH do not have the same priority, the terminal apparatus 1 may transmit the PUCCH having a higher priority, and may not transmit the PUCCH having a lower priority.

A not being earlier than B may be A being later than B, or the starts of A and B being equal. A not being earlier than B may be the start of A not being earlier than the start of B. A being later than B may be the start of A being later than the start of B. A being earlier than B may be the start of A being earlier than the start of B.

Overlapping may mean that at least one symbol of the respective symbols included in the multiple physical channels overlaps in the time domain. For example, the PUCCH resource overlapping may mean that the first PUCCH resource overlaps the second PUCCH resource or the first PUSCH in the time domain.

In the present embodiment, the symbol may be an OFDM symbol, unless otherwise specified.

In a case that the terminal apparatus 1 is configured to transmit multiple PUCCH resources including a semi-persistent CSI report or a periodic CSI report in one slot, and the terminal apparatus 1 is not given a higher layer parameter multi-CSI-PUCCH-ResourceList, the terminal apparatus 1 may determine a first resource in accordance with a CSI report priority. The first PUCCH resource may be a PUCCH resource. In a case that the first resource is configured in PUCCH format 2, and one or multiple resources other than the first resource are not overlapped on the first resource in a slot including the first resource, the terminal apparatus 1 may determine a second resource having the highest CSI report priority in those one or multiple resources other than the first resource. In a case that the first resource is configured in PUCCH format 3 or PUCCH format 4, and one or multiple resources other than the first resource are not overlapped on the first resource in a slot including the first resource, and those one or multiple resources other than the first resource are configured in PUCCH format 2, the terminal apparatus 1 may determine the second resource having the highest CSI report priority in those one or multiple resources other than the first resource.

In a case that the terminal apparatus 1 is configured to transmit multiple PUCCH resources including a semi-persistent CSI report or a periodic CSI report in one slot, and there are three or more PUCCH resources not overlapped in that one slot, the terminal apparatus 1 may determine a first resource in accordance with a CSI report priority. The first PUCCH resource may be a PUCCH resource. In a case that the first resource is configured in PUCCH format 2, and one or multiple resources other than the first resource are not overlapped on the first resource in a slot including the first resource, the terminal apparatus 1 may determine a second resource having the highest CSI report priority in those one or multiple resources other than the first resource. In a case that the first resource is configured in PUCCH format 3 or PUCCH format 4, and one or multiple resources other than the first resource are not overlapped on the first resource in a slot including the first resource, and those one or multiple resources other than the first resource are configured in PUCCH format 2, the terminal apparatus 1 may determine the second resource having the highest CSI report priority in those one or multiple resources other than the first resource.

In a case that the terminal apparatus 1 is given the higher layer parameter multi-CSI-PUCCH-ResourceList and multiple PUCCH resources overlap, the terminal apparatus 1 may multiples multiple CSI reports included in the multiple PUCCH resources on the PUCCH resource provided at least based on the higher layer parameter multi-CSI-PUCCH-ResourceList. Here, the terminal apparatus 1 may expect that the N_{PUCCH}^{repeat is} 1 for PUCCH format 3 or PUCCH format 4 included in the PUCCH resource the is provided at least based on the higher layer parameter multi-CSI-PUCCH-ResourceList. Here, the base device 3 may not configure nrofSlots for PUCCH format 3 or PUCCH format 4 included in the PUCCH resource the is provided at least based on the higher layer parameter multi-CSI-PUCCH-ResourceList, such that N_{PUCCH}^{repeat} is 1 for PUCCH format 3 or PUCCH format 4 included in the PUCCH resource the is provided at least based on the higher layer parameter multi-CSI-PUCCH-ResourceList.

The CSI report priority may be the order of aperiodic CSI report transmitted on PUSCH>semi-persistent CSI report transmitted on PUSCH>semi-persistent CSI report transmitted on PUCCH>periodic CSI report transmitted on PUCCH. The aperiodic CSI report transmitted on the PUSCH may have the highest CSI report priority. The periodic CSI report transmitted on the PUCCH may have the lowest CSI report priority. The semi-persistent CSI report transmitted on the PUCCH may have the CSI report priority higher than the periodic CSI report transmitted on the PUCCH.

In a case that the terminal apparatus 1 is given a higher layer parameter simultaneousHARQ-ACK-CSI, the terminal apparatus 1 may multiplex HARQ-ACK information with or without a scheduling request and a CSI report on one PUCCH. In a case that the terminal apparatus 1 is not given the higher layer parameter simultaneousHARQ-ACK-CSI, the terminal apparatus 1 may drop the PUCCH resource including the CSI report and transmit the PUCCH including the HARQ-ACK information with or without the scheduling request. In a case that the terminal apparatus 1 transmits one or multiple PUCCHs including HARQ-ACK information and/or a CSI report in one slot, the terminal apparatus 1 may expect that the simultaneous-HARQ-ACK-CSI having the same configuration is provided to all the PUCCH formats included in the PUCCH resource.

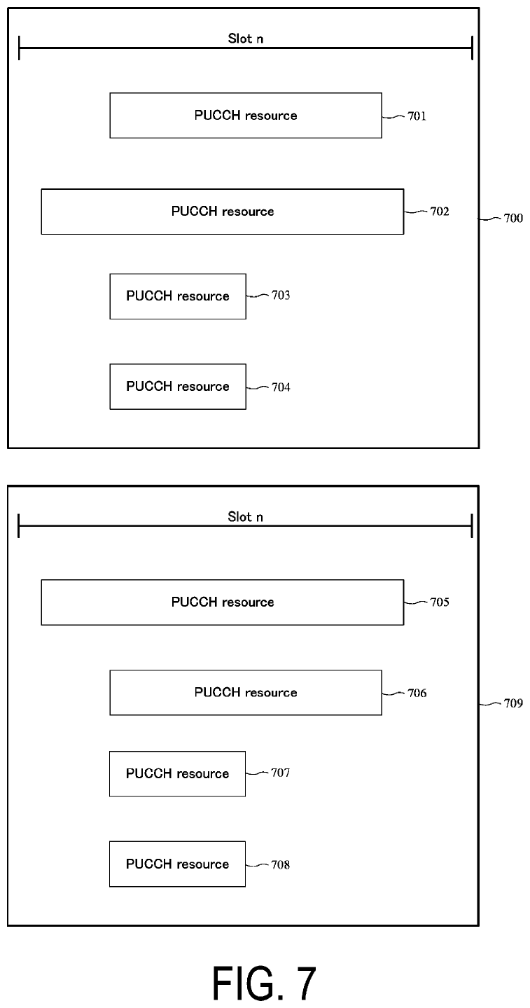

In a case that the terminal apparatus transmits one or multiple PUCCHs including HARQ-ACK information, a scheduling request, and a CSI report in one slot, and a PUCCH including the HARQ-ACK information in the slot satisfies a processing timeline requirement for the PUCCH transmission, and the PUCCH including the HARQ-ACK information in the slot is not overlapped on a PUCCH or PUSCH not satisfying the processing timeline for the PUCCH transmission, the terminal apparatus 1 may multiplex the HARQ-ACK information, the scheduling request, and the CSI report, and determine a new PUCCH resource corresponding to the multiplex of the HARQ-ACK information, the scheduling request, and the CSI report in the PUCCH transmission in the slot. For example, in a case that a PUCCH resource A1 including UCI 1 overlaps a PUCCH resource A2 including UCI 2, and the terminal apparatus 1 multiplexes the UCI 2 on the UCI 1, the terminal apparatus 1 may determine a new PUCCH resource A3 in accordance with the procedure illustrated in FIG. 7 to transmit the UCI 1 and the UCI 2. Here, the new PUCCH resource A3 may be different from or the same as the PUCCH resource A1. The new PUCCH resource A3 may be different from or the same as the PUCCH resource A2.

In a case that the terminal apparatus transmits one or multiple PUCCHs not including HARQ-ACK information in one slot, and the one or multiple PUCCHs do not overlap the PUSCH transmission scheduled by the DCI format, the processing timeline requirement for the PUCCH transmission may not be applied.

In a case that all of the following conditions B1 to B4 are satisfied, the terminal apparatus 1 multiplexes HARQ-ACK information and/or a scheduling request on a PUCCH resource for PUCCH transmission with a CSI report having a high CSI report priority.
Condition B1: The terminal apparatus is not given the higher layer parameter multi-CSI-PUCCH-ResourceList.
Condition B2: A resource for PUCCH transmission with HARQ-ACK information corresponding to SPS PDSCH reception, and/or a resource for PUCCH transmission related to a scheduling request occasion are overlapped on two resources for the respective PUCCH transmissions with two CSI reports in the time domain.
Condition B3: A resource for PUCCH transmission with HARQ-ACK information corresponding to DCI format detection does not overlap other resources.
Condition B4: HARQ-ACK information and/or a scheduling request are multiplexed on two PUCCH transmissions with CSI reports.

In one slot, a set of one or more PUCCH resources corresponding to one or multiple PUCCH transmissions may be Q. Here, the terminal apparatus 1 may order PUCCH resources included in the set Q of PUCCH resources at least in accordance with the following procedures C1 to C3.
Procedure C1: A PUCCH resource with the first symbol being earlier may be placed before a PUCCH resource with the first symbol being later.
Procedure C2: In a case that the first symbols are the same symbol in the procedure C1, the PUCCH resource having a larger number of symbols may be placed before the PUCCH resource having a smaller number of symbols.
Procedure C3: In the case of a PUCCH resource that satisfies none of the procedure C1 and the procedure C2, the terminal apparatus 1 may not perform the ordering procedures. ′ The “being placed before” may mean that an index is smaller in the set Q of PUCCH resources.

FIG. 7 is a diagram illustrating an example of an ordering method of the set Q of PUCCH resources in the present embodiment. 700 may represent the set Q of PUCCH resources before the ordering, or 709 may be the set Q of PUCCH resources after the ordering. In 700, the terminal apparatus 1 assigns a low index to a PUCCH resource 702 with the first symbol being the earliest. The index assigned to 702 may be 0. Since the first symbols of 701, 703, and 704 are the same symbol, the terminal apparatus 1 may assign an index subsequent to 702 to the PUCCH resource 701 having the largest number of symbols among 701, 703, and 704 in accordance with the procedure C2. The index of 701 may be 1. In addition, since 707 and 708 have the same first symbols and have the same number of symbols, the terminal apparatus 1 may not perform the ordering. The terminal apparatus 1 may assign an index of 2 to the PUCCH resource 703, or may assign an index of 3 to the PUCCH resource 704. 701 may be 706. 702 may be 705. 703 may be 707. 704 may be 708.

In a case that the PUCCH resource used for negative SR transmission in the set Q of PUCCH resources does not overlap a PUCCH resource used for HARQ-ACK information and/or a CSI report, the terminal apparatus 1 may exclude the PUCCH resource used for the negative SR transmission from the set Q of PUCCH resources.

In a case that, in the set Q of PUCCH resources, the higher layer parameter simultaneousHARQ-ACK-CSI is not given to the terminal apparatus 1, and a PUCCH resource for transmitting HARQ-ACK information includes PUCCH format 0 or PUCCH format 2, and the PUCCH resource for transmitting the HARQ-ACK information overlaps a PUCCH resource for transmitting a CSI report, the terminal apparatus 1 may exclude the PUCCH resource for transmitting the CSI report from the set Q of the PUCCH resources. Here, the PUCCH resource for transmitting the CSI report may include PUCCH format 2 or PUCCH format 3 or PUCCH format 4.

In a case that, in the set Q of PUCCH resources, the higher layer parameter simultaneousHARQ-ACK-CSI is not given to the terminal apparatus 1, and a PUCCH resource for transmitting HARQ-ACK information includes PUCCH format 1 or PUCCH format 3 or PUCCH format 4, the terminal apparatus 1 may exclude a PUCCH resource for transmitting a CSI report from the set Q of the PUCCH resources. Here, the PUCCH resource transmitting the CSI report may include PUCCH format 3 or PUCCH format 4.

In a case that, in the set Q of PUCCH resources, the higher layer parameter simultaneousHARQ-ACK-CSI is not given to the terminal apparatus 1, and a PUCCH resource for transmitting HARQ-ACK information includes PUCCH format 1 or PUCCH format 3 or PUCCH format 4, and a PUCCH resource for transmitting a CSI report is configured in PUCCH format 2, and the PUCCH resource for transmitting the CSI report overlaps the PUCCH resource for transmitting the HARQ-ACK information, the terminal apparatus 1 may exclude the PUCCH resource for transmitting the CSI report from the set Q of the PUCCH resources.

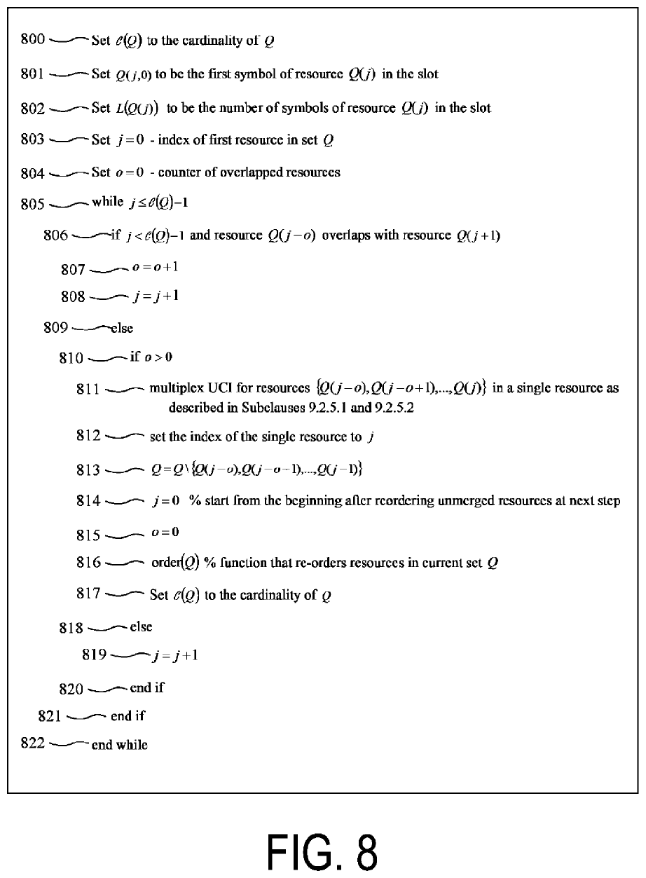

FIG. 8 is a diagram illustrating an example of a procedure in a case that one or multiple PUCCH resources included in the set Q of PUCCH resources in one slot overlap in the present embodiment.
(800) Set C(Q) to the number of elements of the set Q of PUCCH resources and go to 801.
(801) Set Q(j, 0) to an index of the first symbol of a PUCCH resource having an index of j included in the set Q of the PUCCH resources, and go to 802. Q(j) may be for the PUCCH resource having the index of j in the PUCCH resources included in the set Q of the PUCCH resources.
(802) Set L(Q(j)) to the number of symbols of the PUCCH resource Q(j) and go to 803.
(803) Set 0 to a variable j of the index of the first PUCCH resource included in the set Q of PUCCH resources and go to 804.
(804) Set 0 to a counter o counting the overlap of PUCCH resources and go to 805.
(805) In a case that j is the same as or smaller than C(Q)−1, go to 806. In a case that j is larger than C(Q)−1, go to 822 to end the procedure.
(806) In a case that j is smaller than C(Q)−1, and a PUCCH resource Q(j−0) overlaps a PUCCH resource Q(j+1), increment o by one (in 807), increment j by one
(in 808), and go to 805.
(809) In a case that j is the same as or larger than C(Q)−1, or the PUCCH resource Q(j−0) does not overlap the PUCCH resource Q(j+1), go to 810.
(810) In a case that o is larger than 0, go to 811.
(811) The terminal apparatus 1 selects one new PUCCH resource and multiplexes UCI corresponding to the PUCCH resources Q(j−o), Q(j−o+1), . . . , Q(j) on the new PUCCH resource, and the procedure goes to 812. The new PUCCH resource with the index j may be an old PUCCH resource for an index j+1 or greater. In 811, each of the PUCCH resources Q (j−o+1), . . . , Q(j) overlaps the PUCCH resource Q(j−o).
(812) Set j to the index of the new PUCCH resource and go to 813.
(813) Exclude the overlapping PUCCH resources Q(j−o), Q(j−o+1), . . . , Q(j) before processing in 811 from the set Q of PUCCH resources and go to 814.
(814) Set 0 to j and go to 815.
(815) Set 0 too and go to 816.
(816) Order the set Q of PUCCH resources according to the ordering method illustrated in FIG. 7 and go to 817.
(817) Set C(Q) to the number of elements of the set Q of PUCCH resources and go to 805.
(818) In a case that o is the same as or smaller than 0, go to 819.
(819) Increment j by one and go to 805.

The PUCCH resources Q (j−o+1), . . . , Q(j) in 811 are referred to as old PUCCH resources.

In 811, in a case that the higher layer parameter nrofSlots is not given to the old PUCCH resources, the terminal apparatus 1 may not expect that the higher layer parameter nrofSlots is given to the new PUCCH resource. In other words, in 811, in a case that the higher layer parameter nrofSlots is not given to the old PUCCH resources, the terminal apparatus 1 may assume that the higher layer parameter nrofSlots is not given to the new PUCCH resource to perform the procedure (process in 811) for the case that one or multiple PUCCH resources included in the set Q of PUCCH resources in one slot overlap.

In a case that the terminal apparatus 1 attempts to transmit one or multiple PUCCHs including at least two of HARQ-ACK information, a scheduling request, and a CSI report in one slot, and those one or multiple PUCCHs include PUCCH format 1, PUCCH format 3, or PUCCH format 4, the terminal apparatus 1 may expect that nrofSlots having the same configuration is given to PUCCH format 1, PUCCH format 3, and PUCCH format 4. nrofSlots having the same configuration being given to PUCCH format 1, PUCCH format 3, and PUCCH format 4 may mean that N_{PUCCH}^{repeat} for PUCCH format 1, N_{PUCCH}^{repeat} for PUCCH format 3, and N_{PUCCH}^{repeat} for PUCCH format 4 are the same. Here, the base station apparatus 3 may not configure for the terminal apparatus 1 with nrofSlots for PUCCH format 1, PUCCH format 3, and PUCCH format 4 such that N_{PUCCH}^{repeat} for PUCCH format 1, N_{PUCCH}^{repeat} for PUCCH format 3, and N_{PUCCH}^{repeat} for PUCCH format 4 all are 1. Here, the base station apparatus 3 may configure for the terminal apparatus 1 with nrofSlots for PUCCH format 1, nrofSlots for PUCCH format 3, and nrofSlots for PUCCH format 4 such that N_{PUCCH}^{repeat} for PUCCH format 1, N_{PUCCH}^{repeat} for PUCCH format 3, and N_{PUCCH}^{repeat} for PUCCH format 4 are the same.

In a case that the terminal apparatus 1 transmits one or multiple PUCCHs including at least two CSI reports corresponding to different PUCCH resources in one slot, and those one or multiple PUCCHs include PUCCH format 3 or PUCCH format 4, the terminal apparatus 1 may expect that nrofSlots having the same configuration is given to PUCCH format 3 and PUCCH format 4.

In one slot for the terminal apparatus 1 to transmit the PUCCH, the base station apparatus 3 may configure for the new PUCCH resource with a configuration the same as the old PUCCH resource configured by the higher layer parameter nrofSlots.

The base station apparatus 3 may not configure for the terminal apparatus 1 with nrofSlots for the PUCCH format corresponding to the old PUCCH resource and the PUCCH format corresponding to the new PUCCH resource such that N_{PUCCH}^{repeat} for the PUCCH format corresponding to the old PUCCH resource and N_{PUCCH}^{repeat} for the PUCCH format corresponding to the new PUCCH resource are the same in one slot for the terminal apparatus 1 to transmit the PUCCH.

The base station apparatus 3 may configure nrofSlots for the PUCCH format corresponding to the old PUCCH resource and nrofSlots for the PUCCH format corresponding to the new PUCCH resource such that N_{PUCCHP}^{repeat} for the PUCCH format corresponding to the old PUCCH resource and N_{PUCCH}^{repeat} for the PUCCH format corresponding to the new PUCCH resource are the same in one slot for the terminal apparatus 1 to transmit the PUCCH.

In the procedure for the case illustrated in FIG. 8 that one or multiple PUCCH resources included in the set Q of PUCCH resources in one slot overlap, the terminal apparatus 1 may ignore the configuration of the higher layer parameter nrofSlots. The terminal apparatus 1 ignoring the configuration of the higher layer parameter nrofSlots may mean that nrofSlots is 1. The terminal apparatus 1 ignoring the configuration of the higher layer parameter nrofSlots may mean that N_{PUCCH}^{repeat} is 1.

In the procedure for the case illustrated in FIG. 8 that one or multiple PUCCH resources included in the set Q of PUCCH resources in one slot overlap, in a case that the higher layer parameter nrofSlots is given to a PUCCH format, the PUCCH format may not be selected for the new PUCCH resource.

In the procedure of selecting the PUCCH resource for the case illustrated in FIG. 8 that one or multiple PUCCH resources included in the set Q of PUCCH resources in one slot overlap, a PUCCH resource configured with a PUCCH format including the higher layer parameters nrofSlots may not be selected as a new PUCCH resource.

In the procedure of selecting the PUCCH resource for the case illustrated in FIG. 8 that one or multiple PUCCH resources included in the set Q of PUCCH resources in one slot overlap, the terminal apparatus 1 may not select a PUCCH resource configured with a PUCCH format including the higher layer parameters nrofSlots a new PUCCH resource.

In the procedure of selecting the PUCCH resource for the case illustrated in FIG. 8 that one or multiple PUCCH resources included in the set Q of PUCCH resources in one slot overlap, the base station apparatus 1 may not expect that a PUCCH resource configured with a PUCCH format including the higher layer parameters nrofSlots is selected and received as a new PUCCH resource.

The higher layer parameter nrofSlots may be configured per a PUCCH resource. In the case that the higher layer parameter nrofSlots is configured per a PUCCH resource, nrofSlots may be given a value different per a PUCCH format.

In 811, the terminal apparatus 1 may expect that N_{PUCCH}^{repeat} is 1 for a new PUCCH resource including the PUSCH format 1, 3, or 4. In other words, in 811, the base station apparatus 3 may not configure nrofSlots for PUCCH format 1, 3, or 4 included in the new PUCCH resource such that N_{PUCCH}^{repeat} is 1 for the new PUCCH resource including PUCCH format 1, 3, or 4.

Hereinafter, various aspects of the terminal apparatus 1 and the base station apparatus 3 according to the present embodiment will be described.

(1) A first aspect of the present embodiment is a terminal apparatus including a processing unit configured to resolve overlapping of multiple PUCCH resources, and a transmitter configured to transmit a PUCCH as an output of the processing unit, wherein in a case that a first PUCCH resource overlaps a second PUCCH resource, the processing unit multiplexes first UCI included in the first PUCCH resource and second UCI included in the second PUCCH resource into a third PUCCH resource, a first parameter N_{PUCCH}^{repeat} for a first PUCCH format of the first PUCCH resource and a second parameter N_{PUCCH}^{repeat} for a second PUCCH format of the second PUCCH resource are expected to be identical to a third parameter N_{PUCCH}^{repeat} for a third PUCCH format of the third PUCCH resource, the first parameter N_{PUCCH}^{repeat} is related to the number of slots in which the first PUCCH resource having the first PUCCH format is repeated, the second parameter N_{PUCCH}^{repeat} is related to the number of slots in which the first PUCCH resource having the first PUCCH format is repeated, the third parameter N_{PUCCH}^{repeat} is related to the number of slots in which the first PUCCH resource having the first PUCCH format is repeated, and the third PUCCH format is different from the first PUCCH format and the second PUCCH format.

(2) In the first aspect of the present embodiment, the first PUCCH format is identical to the second PUCCH format.

(3) In the first aspect of the present embodiment, the first PUCCH format is different from the second PUCCH format.

(4) In the first aspect of the present embodiment, the first parameter N_{PUCCH}^{repeat} and the second parameter N_{PUCCH}^{repeat} each are one.

(5) A second aspect of the present embodiment is a base station apparatus including a processing unit configured to resolve overlapping of multiple PUCCH resources, and a receiver configured to receive a PUCCH as an output of the processing unit, wherein in a case that a first PUCCH resource overlaps a second PUCCH resource, the processing unit multiplexes first UCI included in the first PUCCH resource and second UCI included in the second PUCCH resource into a third PUCCH resource, a first parameter N_{PUCCH}^{repeat} for a first PUCCH format of the first PUCCH resource and a second parameter N_{PUCCH}^{repeat} for a second PUCCH format of the second PUCCH resource are configured to be identical to a third parameter N_{PUCCH}^{repeat} for a third PUCCH format of the third PUCCH resource, the first parameter N_{PUCCH}^{repeat} is related to the number of slots in which the first PUCCH resource having the first PUCCH format is repeated, the second parameter N_{PUCCH}^{repeat} is related to the number of slots in which the first PUCCH resource having the first PUCCH format is repeated, the third parameter N_{PUCCH}^{repeat} is related to the number of slots in which the first PUCCH resource having the first PUCCH format is repeated, and the third PUCCH format is different from the first PUCCH format and the second PUCCH format.

(6) In the second aspect of the present embodiment, the first PUCCH format is identical to the second PUCCH format.

(7) In the second aspect of the present embodiment, the first PUCCH format is different from the second PUCCH format.

(8) In the second aspect of the present embodiment, the first parameter N_{PUCCH}^{repeat} and the second parameter N_{PUCCH}^{repeat} each are one. Consequently, the terminal apparatus 1 and the base station apparatus 3 can communicate efficiently.

A program running on each of the base station apparatus 3 and the terminal apparatus 1 according to the present invention may be a program (that causes a computer to function) that controls a Central Processing Unit (CPU) and the like, such that the program realizes the functions of the above-described embodiment according to the present invention. The information handled in these devices is temporarily stored in a Random Access Memory (RAM) while being processed. Thereafter, the information is stored in various types of Read Only Memory (ROM) such as a Flash ROM and a Hard Disk Drive (HDD), and when necessary, is read by the CPU to be modified or rewritten.

Note that the terminal apparatus 1 and the base station apparatus 3 according to the above-described embodiment may be partially achieved by a computer. In such a case, a program for realizing such control functions may be recorded on a computer-readable recording medium to cause a computer system to read the program recorded on the recording medium for execution.

Note that it is assumed that the “computer system” mentioned here refers to a computer system built into the terminal apparatus 1 or the base station apparatus 3, and the computer system includes an OS and hardware components such as a peripheral apparatus. Furthermore, the “computer-readable recording medium” refers to a portable medium such as a flexible disk, a magneto-optical disk, a ROM, a CD-ROM, and the like, and a storage apparatus such as a hard disk built into the computer system.

The “computer-readable recording medium” may include a medium that dynamically retains the program for a short period of time, such as a communication line that is used to transmit the program over a network such as the Internet or over a communication line such as a telephone line, and a medium that retains, in that case, the program for a certain period of time, such as a volatile memory within the computer system which functions as a server or a client. The program may be configured to realize some of the functions described above, and also may be configured to be capable of realizing the functions described above in combination with a program already recorded in the computer system.

Furthermore, the base station apparatus 3 according to the above-described embodiment may be achieved as an aggregation (apparatus group) including multiple apparatuses. Each of the apparatuses constituting such an apparatus group may include some or all portions of each function or each functional block of the base station apparatus 3 according to the above-described embodiment. The apparatus group is required to have a complete set of functions or functional blocks of the base station apparatus 3. Furthermore, the terminal apparatus 1 according to the above-described embodiment can also communicate with the base station apparatus as the aggregation. Furthermore, the base station apparatus 3 according to the above-described embodiment may serve as an Evolved Universal Terrestrial Radio Access Network (EUTRAN). Furthermore, the base station apparatus 3 according to the above-described embodiment may have some or all of the functions of a node higher than an eNodeB.

Furthermore, some or all portions of each of the terminal apparatus 1 and the base station apparatus 3 according to the above-described embodiment may be typically achieved as an LSI which is an integrated circuit or may be achieved as a chip set. The functional blocks of each of the terminal apparatus 1 and the base station apparatus 3 may be individually achieved as a chip, or some or all of the functional blocks may be integrated into a chip. A circuit integration technique is not limited to the LSI, and may be realized with a dedicated circuit or a general-purpose processor. Furthermore, in a case where with advances in semiconductor technology, a circuit integration technology with which an LSI is replaced appears, it is also possible to use an integrated circuit based on the technology.

Furthermore, according to the above-described embodiment, the terminal apparatus has been described as an example of a communication apparatus, but the present invention is not limited to such a terminal apparatus, and is applicable to a terminal apparatus or a communication apparatus of a fixed-type or a stationary-type electronic apparatus installed indoors or outdoors, for example, such as an Audio-Video (AV) apparatus, a kitchen apparatus, a cleaning or washing machine, an air-conditioning apparatus, office equipment, a vending machine, and other household apparatuses.

The embodiments of the present invention have been described in detail above referring to the drawings, but the specific configuration is not limited to the embodiments and includes, for example, an amendment to a design that falls within the scope that does not depart from the gist of the present invention. Various modifications are possible within the scope of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

1. A terminal apparatus comprising:
a processing unit configured to resolve overlapping of multiple physical uplink control channel (PUCCH) resources; and
a transmitter configured to transmit a PUCCH as an output of the processing unit, wherein
in a case that a first PUCCH resource overlaps a second PUCCH resource, the processing unit multiplexes first uplink control information (UCI) included in the first PUCCH resource and second UCI included in the second PUCCH resource into a third PUCCH resource,
a first parameter N_{PUCCH}^{repeat} for a first PUCCH format of the first PUCCH resource and a second parameter N_{PUCCH}^{repeat} for a second PUCCH format of the second PUCCH resource are expected to be identical to a third parameter N_{PUCCH}^{repeat} for a third PUCCH format of the third PUCCH resource,
the first parameter N_{PUCCH}^{repeat} is related to the number of slots in which the first PUCCH resource having the first PUCCH format is repeated,
the second parameter N_{PUCCH}^{repeat} is related to the number of slots in which the second PUCCH resource having the second PUCCH format is repeated,
the third parameter N_{PUCCH}^{repeat} is related to the number of slots in which the third PUCCH resource having the third PUCCH format is repeated, and
the third PUCCH format is different from the first PUCCH format and the second PUCCH format.

2. The terminal apparatus according to claim 1, wherein the first PUCCH format is identical to the second PUCCH format.

3. The terminal apparatus according to claim 1, wherein the first PUCCH format is different from the second PUCCH format.

4. The terminal apparatus according to claim 1, wherein the first parameter N_{PUCCH}^{repeat} and the second parameter N_{PUCCH}^{repeat} each are one.

5. A base station apparatus comprising:
a processing unit configured to resolve overlapping of multiple physical uplink control channel (PUCCH) resources; and
a receiver configured to receive a PUCCH as an output of the processing unit, wherein
in a case that a first PUCCH resource overlaps a second PUCCH resource, the processing unit multiplexes first uplink control information (UCI) included in the first PUCCH resource and second UCI included in the second PUCCH resource into a third PUCCH resource,
a first parameter N_{PUCCH}^{repeat} for a first PUCCH format of the first PUCCH resource and a second parameter N_{PUCCH}^{repeat} for a second PUCCH format of the second PUCCH resource are configured to be identical to a third parameter N_{PUCCH}^{repeat} for a third PUCCH format of the third PUCCH resource,
the first parameter N_{PUCCH}^{repeat} is related to the number of slots in which the first PUCCH resource having the first PUCCH format is repeated,
the second parameter N_{PUCCH}^{repeat} is related to the number of slots in which the second PUCCH resource having the second PUCCH format is repeated,
the third parameter N_{PUCCH}^{repeat} is related to the number of slots in which the third PUCCH resource having the third PUCCH format is repeated, and
the third PUCCH format is different from the first PUCCH format and the second PUCCH format.

6. The base station apparatus according to claim 5, wherein the first PUCCH format is identical to the second PUCCH format.

7. The base station apparatus according to claim 5, wherein the first PUCCH format is different from the second PUCCH format.

8. The base station apparatus according to claim 5, wherein the first parameter N_{PUCCH}^{repeat} and the second parameter N_{PUCCH}^{repeat} each are one.

9. A communication method used for a terminal apparatus, the communication method comprising the steps of:
resolving overlapping of multiple physical uplink control channel (PUCCH) resources; and
transmitting a PUCCH as an output in the processing step, wherein
in a case that a first PUCCH resource overlaps a second PUCCH resource, the processing step includes multiplexing first uplink control information (UCI) included in the first PUCCH resource and second UCI included in the second PUCCH resource into a third PUCCH resource,
a first parameter N_{PUCCH}^{repeat} for a first PUCCH format of the first PUCCH resource and a second parameter N_{PUCCH}^{repeat} for a second PUCCH format of the second PUCCH resource are expected to be identical to a third parameter N_{PUCCH}^{repeat} for a third PUCCH format of the third PUCCH resource,
the first parameter N_{PUCCH}^{repeat} is related to the number of slots in which the first PUCCH resource having the first PUCCH format is repeated,
the second parameter N_{PUCCH}^{repeat} is related to the number of slots in which the second PUCCH resource having the second PUCCH format is repeated,
the third parameter N_{PUCCH}^{repeat} is related to the number of slots in which the third PUCCH resource having the third PUCCH format is repeated, and
the third PUCCH format is different from the first PUCCH format and the second PUCCH format.

10. (canceled)
